(19) United States
(12) Patent Application Publication
(10) Pub. No.: US 2013/0097055 A1
(43) Pub. Date: Apr. 18, 2013

(54) METHODS AND SYSTEMS FOR TRANSFERRING LIQUOR LICENSES

(71) Applicants: Daniel J. Kramer, San Francisco, CA (US); Nathaniel Haas, San Francisco, CA (US); Benjamin Haas, San Francisco, CA (US)

(72) Inventors: Daniel J. Kramer, San Francisco, CA (US); Nathaniel Haas, San Francisco, CA (US); Benjamin Haas, San Francisco, CA (US)

(21) Appl. No.: 13/447,824

(22) Filed: Apr. 16, 2012

Related U.S. Application Data
(60) Provisional application No. 61/559,509, filed on Nov. 14, 2011.
(60) Provisional application No. 61/546,788, filed on Oct. 13, 2011.

(51) Int. Cl. G06Q 30/00

(52) U.S. Cl. 705/26.25

(57) ABSTRACT

The present invention relates to a method for facilitating transfer of an available liquor license on a wide area network that includes, in operable communication, a buyer system, a seller system and a liquor license transfer system, the method including: a) the liquor license transfer system displaying on the buyer system a listing of the available liquor license and at least one comparable; b) the liquor license transfer system receiving an offer for the available liquor license and validating the offer; c) the liquor license transfer system generating and transmitting a notification of the offer to the seller system; and d) upon the liquor license transfer system receiving an acceptance, the liquor license transfer system retrieving one or more electronic forms required to effectuate transfer of ownership of the available liquor license and auto-populating the forms with information relating to the buyer system and the seller system.

### CROSS-REFERENCE TO RELATED APPLICATION

The present application claims the benefit of U.S. Provisional Patent Application Ser. No. 61/559,509, filed Nov. 14, 2011 and U.S. Provisional Patent Application Ser. No. 61/546,788, filed Oct. 13, 2011, the entireties of which are hereby incorporated by reference.

### FIELD OF THE INVENTION

The present invention relates generally to a method of buying, selling and transferring liquor licenses through a centralized electronic marketplace.

### BACKGROUND OF THE INVENTION

Although liquor licenses in each State are issued and controlled by a State or County governmental agency, in some states (such as Arizona, California, Florida, Massachusetts, New Jersey, Ohio and Pennsylvania) certain types of liquor licenses are traded on the open-market. However, in each of these states, these liquor license markets suffer from a number of systemic problems, including: (i) willing buyers and sellers have difficulty finding one another because there is no liquor license transfer (LLT) system through which to conduct transactions; (ii) sellers have no dedicated venue to advertise that they want to sell a liquor license, and buyers have no dedicated venue to advertise that they want to purchase a license as there are currently no other websites or publications that list licenses for sale/wanted, (iii) licenses sell for different prices in different counties, but buyers and sellers are typically unaware of the fair market value of a license in their specific County because comparison sales data cannot be easily obtained by the general public; and (iv) buyers and sellers pay high fees to brokers (usually 10% or more of the price of the license) as a result of this lack of a LLT system and available data.

Many buyers and sellers do not like using brokers because brokers (i) are not licensed, (ii) often take their finder's fees up front regardless of whether the transaction closes, (iii) often make sellers sign exclusivity agreements, and (iv) do not actively market sellers' licenses through channels that effectively reach potential buyers, if at all. Therefore, there is a need for an on-line centralized LLT system dedicated to the buying and selling of liquor licenses.

### SUMMARY OF THE INVENTION

These and other needs are met by the present invention, which is directed to a method for facilitating transfer of an available liquor license on a wide area network, the wide area network comprising, in operable communication, a buyer system, a seller system and a liquor license transfer system, the liquor license transfer system comprising a liquor license database, the method comprising: a) the liquor license transfer system displaying on the buyer system a listing of the available liquor license and at least one comparable on a user interface generated by the liquor license transfer system, wherein the at least one comparable is a previously transferred liquor license record that is stored in the liquor license database; b) the liquor license transfer system receiving an offer for the available liquor license from the buyer system and validating the offer; c) upon the liquor license transfer system validating the offer, the liquor license transfer system generating and transmitting a notification of the offer to the seller system; and d) upon the liquor license transfer system receiving an acceptance, the liquor license transfer system retrieving one or more electronic forms required to effectuate transfer of ownership of the available liquor license and auto-populating the forms with information relating to the buyer system and the seller system.

According to another embodiment, the present invention is directed to a method of displaying data for facilitating the transfer of surrendered liquor licenses on a wide area network, the wide area network comprising, in operable communication, a liquor license transfer system, a buyer system and a local control board system, the method comprising: a) the liquor license transfer system searching the local control board system on a periodic basis for surrendered liquor licenses using a data script; b) the liquor license transfer system uploading information relating to the surrendered liquor licenses identified in step a): c) the liquor license transfer system creating an available liquor license listing for each surrendered liquor license and storing the available liquor license listings to a liquor license database residing on the liquor license transfer system, the liquor license database also storing previously transferred liquor license records; d) for each available liquor license listing, the liquor license transfer system searching the previously transferred liquor license records and determining at least one comparable, wherein each comparable is a previously transferred liquor license record; and e) upon a particular available liquor license listing meeting criteria established by the buyer system that is searching the liquor license database, displaying the particular available liquor license listing and the at least one comparable identified in step d) on the buyer system via a user interface generated by the liquor license transfer system.

According to yet another embodiment, the present invention is directed to a method of determining comparable liquor licenses for a liquor license transfer system, the liquor license transfer system comprising a liquor license database and residing on a wide area network, the wide area network comprising, in operable communication, a buyer system and the liquor license transfer system, the method comprising: a) an administrator of the liquor license transfer system reviewing information relating to a plurality of previously transferred liquor licenses, the information comprising a date the liquor license was transferred, a liquor license type, a transferor, a transferee, a transfer type, an address of the liquor license prior to transfer and consideration paid for the transfer; b) upon the administrator approving a particular previously transferred liquor license, the liquor license transfer system storing the information relating to the particular previously transferred liquor license in the liquor license database as a previously transferred liquor license record; wherein the administrator only approves the particular previously transferred liquor license when the information relating to the previously transferred liquor license represents an accurate reflection of fair market value; c) the liquor license transfer system determining at least one comparable for an available liquor license listing, the particular previously transferred liquor license record being one of the at least one comparable for the available liquor license listing; and d) upon receiving a request from the buyer system to display the available liquor license listing, the liquor license transfer system displaying the available liquor license listing and the at least one comparable on the buyer system via a user interface generated by the liquor license transfer system.

According to yet another embodiment, the present invention is directed to a liquor license transfer system for facilitating transfer of an available liquor license comprising: a buyer system, a seller system and a liquor license transfer system in operable communication; the liquor license transfer system comprising a liquor license database and configured to: (1) display on the buyer system a listing of the available liquor license and at least one comparable via a user interface generated by the liquor license transfer system, wherein the at least one comparable is a previously transferred liquor license record that is stored in the liquor license database; (2) receive an offer for the available liquor license from the buyer system; (3) validate the offer; (4) generate a notification of the offer; (5) transmit the notification of the offer to the seller system; (6) receive an acceptance; (7) retrieve one or more electronic forms required to effectuate transfer of ownership of the available liquor license, the forms stored in the liquor license database; and (8) auto-populate the forms with information relating to the buyer system and the seller system.

According to yet another embodiment, the present invention is directed to a liquor license transfer system for facilitating transfer of surrendered liquor licenses comprising: a buyer system, a local control board system and the liquor license transfer system in operable communication; the liquor license transfer system comprising a liquor license database and configured to: (1) search the local control board system on a periodic basis for surrendered liquor licenses using a data script; (2) upload information relating to the surrendered liquor licenses; (3) create an available liquor license listing for each uploaded surrendered liquor licenses; (4) store the available liquor license listings in the liquor license database, the liquor license database also storing previously transferred liquor license records; (5) determine at least one comparable for each available liquor license listing, wherein each comparable is a previously transferred liquor license record; and (6) upon a particular available liquor license listing meeting criteria established by the buyer system that is searching the liquor license database, display the particular available liquor license listing and the at least one comparable on the buyer system via a user interface generated by the liquor license transfer system.

According to yet another embodiment, the present invention is directed to a liquor license transfer system for determining comparable liquor licenses in order to facilitate the transfer of available liquor licenses comprising: a buyer system and the liquor license transfer system, in operable communication; the liquor license transfer system comprising a liquor license database and configured to: (1) review information relating to a plurality of previously transferred liquor licenses, the information comprising a date the liquor license was transferred, a liquor license type, a transferor, a transferee, a transfer type, an address of the liquor license prior to transfer and consideration paid for the transfer; (2) approve a particular previously transferred liquor license; (3) store the information relating to the particular previously transferred liquor license in the liquor license database as a previously transferred liquor license record; (4) determine at least one comparable for an available liquor license listing, the particular previously transferred liquor license record being one of the at least one comparable for the available liquor license listing; and (5) upon receiving a request from the buyer system to display the available liquor license listing, display the available liquor license listing and the at least one comparable on the buyer system via a user interface generated by the liquor license transfer system.

### BRIEF DESCRIPTION OF THE DRAWINGS

FIG. 1 is a schematic diagram of a system for transferring a liquor license according to one embodiment of the present invention.

FIG. 2 is a schematic diagram of a liquor license transfer system for transferring a liquor license according to one embodiment of the present invention.

FIG. 3 is a schematic diagram of a seller system for transferring a liquor license according to one embodiment of the present invention.

FIG. 4 is a schematic diagram of a buyer system for transferring a liquor license according to one embodiment of the present invention.

FIG. 5 is a schematic diagram of a local control board system for transferring a liquor license according to one embodiment of the present invention.

FIGS. 6a-6c are a flowchart portraying a method of transferring a liquor license between a seller system and a buyer system according to one embodiment of the present invention.

FIGS. 7a-7b are a flowchart portraying a method of determining comparables for a new available liquor license listing according to an embodiment of the present invention.

FIG. 8 is a flowchart portraying a method of populating the liquor license database with surrendered liquor licenses according to one embodiment of the present invention.

FIG. 9 is a screen shot from a liquor license transfer system user interface of a searching feature according to one embodiment of the present invention.

FIG. 10 is a screen shot from a liquor license transfer systemuser interface of search results after a search is preformed according to one embodiment of the present invention.

FIG. 11 is a screen shot from a user interface of the mapping feature of the liquor license transfer system according to one embodiment of the present invention.

FIG. 12 is a screen shot from a user interface of the view a license feature, including comparables of the selected license, of the liquor license transfer system according to one embodiment of the present invention.

FIG. 13 is a screen shot from a user interface after a comparables has been selected via the liquor license transfer system according to one embodiment of the present invention.

FIG. 14 is a screen shot from a user interface for a particular seller or buyer's account of the liquor license transfer system according to one embodiment of the present invention.

FIG. 15 is a screen shot from a user interface of transaction information relating to a particular liquor license of the liquor license transfer system according to one embodiment of the present invention.

FIG. 16 is a screen shot from a user interface of the suite of services provided by the liquor license transfer system according to one embodiment of the present invention.

FIG. 17 is a screen shot from a user interface for a seller to add a liquor license to the liquor license transfer system according to one embodiment of the present invention.

### DETAILED DESCRIPTION OF THE INVENTION

The following description of the preferred embodiment(s) is merely exemplary in nature and is in no way intended to limit the invention, its application, or uses.

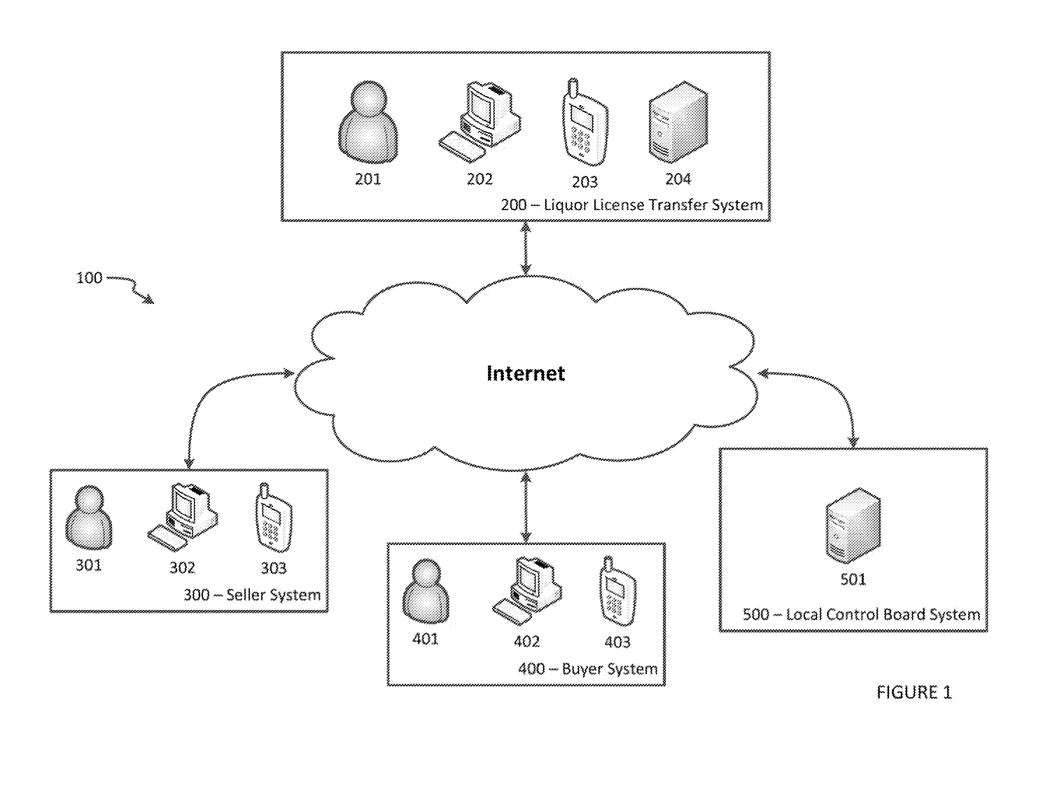

Referring to FIG. 1, a schematic diagram of a system 100 for facilitating the transfer of a liquor license according to one embodiment of the present invention is illustrated. Generally, the system 100 comprises a LLT system 200, at least one seller system 300, at least one buyer system 400 and a local control board system 500 all in operable communication with one another to form a wide area network (WAN).

As exemplified by FIG. 1, the components of the system 100 are in operable communication via the internet. However, the invention is not so limited and other electronic communication means may be utilized, such as a satellite network, a cellular network, a common carrier network(s), Wi-Fi, WiMAX or any combination thereof. Further, it should be noted that operable communication includes any means of electronic communication, such as but not limited to wired and wireless electronic communication, in which data can be transmitted and received between the systems and modules of the system 100. Moreover, it should also be noted that operable communication includes both direct and indirect communication, as well as bi-directional communication between the systems and modules of the system 100.

Although only one seller system 300 and one buyer system 400 are exemplified in FIG. 1, it should be noted that the present invention is not so limited and in alternate embodiments the system 100 may comprises any number of seller or buyer systems 300, 400. Moreover, although only one local control board system 500 is illustrated, the invention is not so limited and in alternate embodiments the system 100 may comprise more than one local control board system 509.

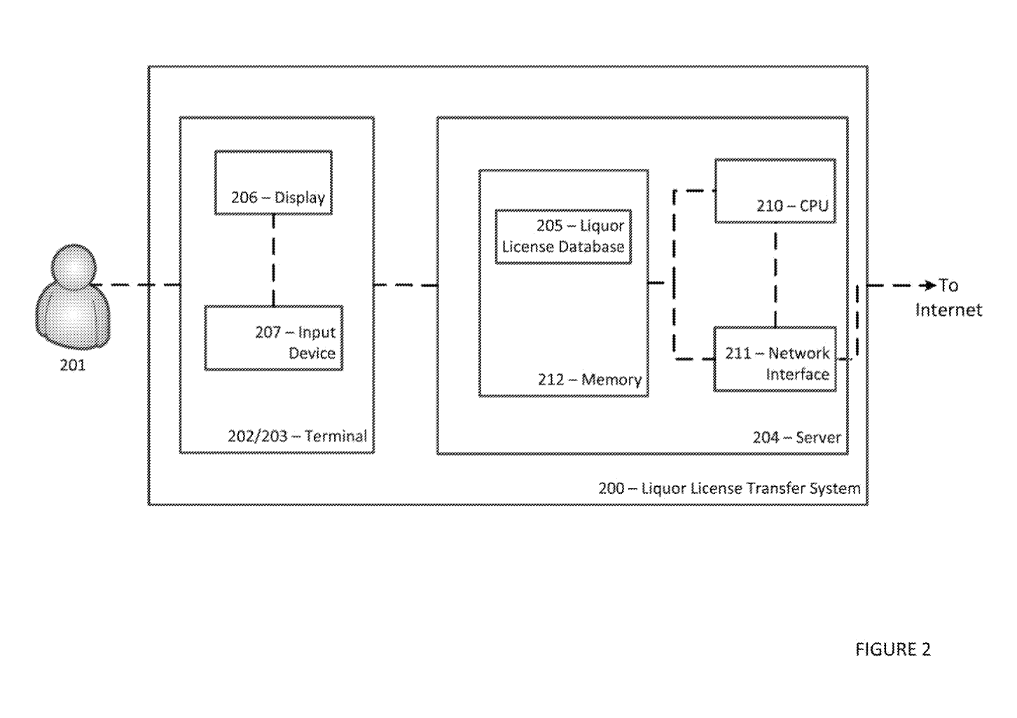

Referring to FIG. 2, a schematic diagram of a LLT system 200 according to one embodiment of the present invention is illustrated. The LLT system 200 comprises a personal computer terminal 202 and a mobile electronic device 203 (collectively defined as a “terminal” 202/203), a server 204, and a liquor license database 205. Further, as discussed in more detail below, the LLT system 200 may also be said to comprise at least one administrator 201. Although exemplified as comprising the above components, the LLT system 200 may comprise any number, more or less; of the components listed above. For example, the LLT system 200 may comprises a plurality of administrators 201, a plurality of personal computer terminals 202, a plurality of mobile electronic devices 203, and/or a plurality of servers 204.

As discussed in more detail below, the LLT system 200 is configured to facilitate the transfer of a liquor license from a seller system 300 to a buyer system 400. The LLT system 200 comprises programs configured to access the other systems on the system 100 and perform the tasks described herein. For example, according to one embodiment of the present invention, the LLT system 200 comprises a data script that is configured to search and upload information from the local control board system 500.

The administrator 201 is an individual who aids in the facilitation of a transfer of a liquor license from a seller system 300 to a buyer system 400. However, the invention is not so limited and in alternate embodiments, the tasks performed by the administrator 201 may be automated and performed by computer executable programs residing on the LLT system 200. The personal computer terminal 202 and mobile electronic device 203 are configured to allow the administrator 201 to access at least the server 204, liquor license database 205 and the local control board system 500. However, it should be noted that in alternate embodiments, the personal computer terminal 202 and/or the mobile electronic device 203 may be omitted from the LLT system 200. Further, as exemplified in FIG. 2, the personal computer terminal 202 and the mobile electronic device 203 may be collectively referred to as a terminal 202/203.

Each terminal 202/203 of the LLT system 200 comprises a properly programmed processor (not shown), a memory device (not shown), a power supply (not shown), a video card (not shown), a display device 206, firmware (not shown), software (not shown), a network interface (not shown) and a user input device 207 (e.g., a keyboard, mouse and/or touch screen). Although not exemplified, it should be understood that the processor of the terminal 202/203 can have integrated memory. The properly programmed processor of the terminal 202/203 is configured to effectuate the processes and functions described below, including, but not limited to the effectuation of the graphical user interfaces (GUI) for display on the display device 206 of the terminal 202/203 for the administrator 201 and the transmission of user inputs from the administrator 201 via the input device 207 to the other systems and modules of the system 100.

The server 204 of the LLT system 200 comprises a properly programmed processor 210, a memory device 212, a network interface 211, a power supply (not shown), a video card (not shown), a display device (not shown), firmware (not shown), software (not shown), a network interface (not shown) and a user input device (not shown) (e.g., a keyboard, mouse and/or touch screen) all in operable communication. It should be noted the processor 210 may be considered the processor of the LLT system 200. Further, although exemplified as a singe server 204, the invention is not so limited and the LLT system 200 may comprise any number of servers 204. Additionally, although not exemplified, it should be understood that the processor 210 can have integrated memory. The properly programmed processor 210 of the LLT system 200 effectuates the performing of the processes and functions described below, including but not limited to, the storage of data to the memory 212 of the LLT system 200, the effectuation of the graphical user interfaces (GUI) for display on the display devices 306/406 of the terminal 302/303/402/403 for the buyers and seller systems 300/400, the search and upload of data/information from the local control board system 500 using the data script residing within the memory of the LLT system 200, and the transfer (transmission and receipt) of data from LLT system 200 to the other systems and modules of the system 100.

In the exemplified embodiment, the memory device 212 of the LLT system 200 comprises a liquor license database 205. Although exemplified as part of the memory 212, in other embodiments the liquor license database 205 may reside elsewhere on the LLT system 200 or on another system altogether. As also discussed in more detail below, the liquor license database 205 stores at least one available liquor license listing and at least one previously transferred liquor license record. An available liquor license listing, as used herein, may be a listing for an inactive or surrendered liquor license (Surrendered License) or an active liquor license offered for sale by a particular seller system 300. Generally, a Surrendered License is one that is not in active use (e.g., the business is no longer operating and/or the owner is not currently selling alcoholic beverages under the license). Further, each available liquor license listing comprises information relating to the actual liquor license itself, such as, but not limited to the license number, license type, business name and business address of the available liquor license.

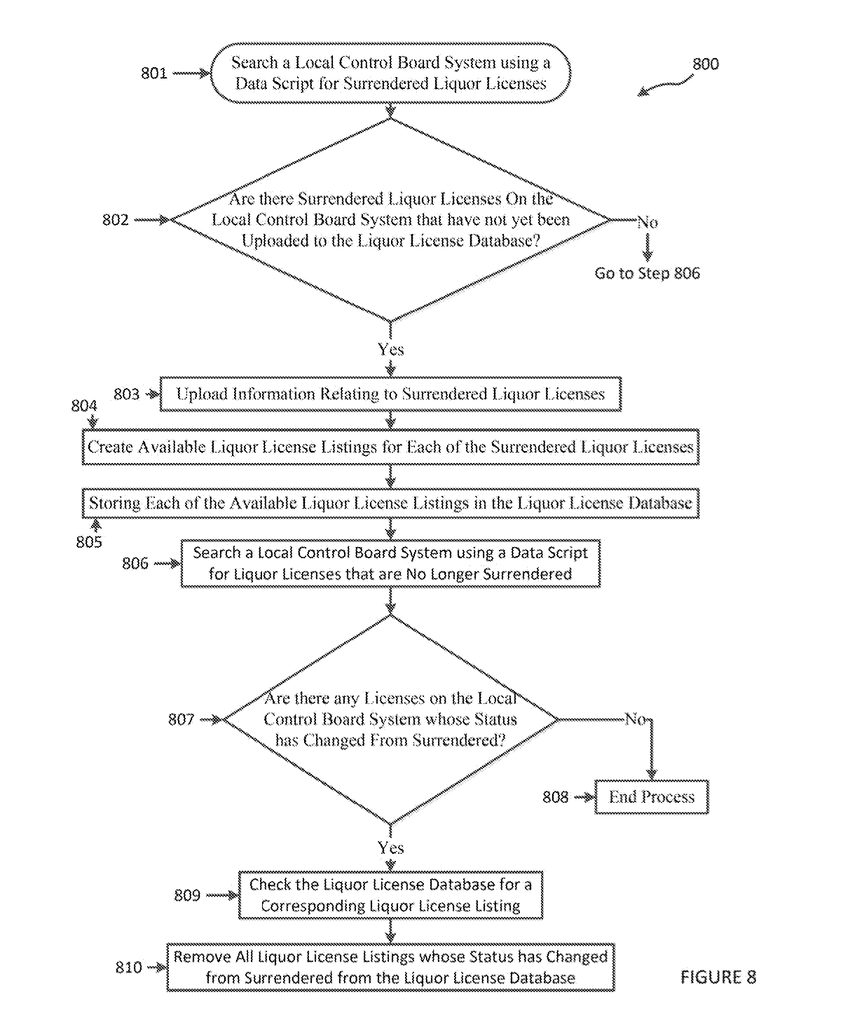

A previously transferred liquor license record is a record of a liquor license that has already been sold by a seller (or licensee) to a buyer (or applicant or transferee). Depending on the laws promulgated by the local control board regarding the information about a liquor license transaction made available to the general public, the record will provide different information about each liquor license transfer. For example, in California, the record comprises information such as, but not limited to the licensee, the applicant, the liquor license type, the premises address, the county and city of the liquor license, and the consideration paid for the liquor license. In other states, such as Arizona and New Jersey, the local control board does not make certain data available to the general public (e.g. names of buyers or sellers, etc.), so the license record on the LLT system in that particular state will not include such information, but rather only include the information deemed public. As discussed in more detail below with reference to FIG. 8, the LLT system 200 determines which previously transferred liquor license records are comparables for each available liquor license listing. Further, as will also be discussed in more detail below, the liquor license database 205 may be accessed and searched by seller and buyer systems 300, 400 in order to facilitate the transfer of a liquor license.

In at least one embodiment, the LLT system 200 may be operable to perform and/or implement various types of functions, operations, actions, and/or other features such as those described or referenced herein, with specific reference to the facilitation of the transfer of a liquor license from a seller system 300 to a buyer system 400. In at least one embodiment, the LLT system 200 may be operable to utilize and/or generate various different types of data and/or other types of information when performing specific tasks and/or operations. This may include, for example, input data/information and/or output data/information in response to an administrator 201, seller system 300 and/or buyer system 400 input. For example, in at least one embodiment, the LLT system 200 may be operable to access, process, and/or otherwise utilize information from one or more different types of sources, such as, for example, the liquor license database 205 or one or more local and/or remote memories, devices and/or systems, such as the seller and buyer systems 300, 400 and the local control board system 500.

Additionally, in at least one embodiment, the LLT system 200 may be operable to generate one or more different types of output data/information, which, for example, may be stored in the liquor license database 205, memory of the server or memory of one or more remote systems. Examples of different types of input data/intbrmation and/or output data/information which may be accessed and/or utilized by the system may include, but are not limited to, one or more of those described and/or referenced herein.

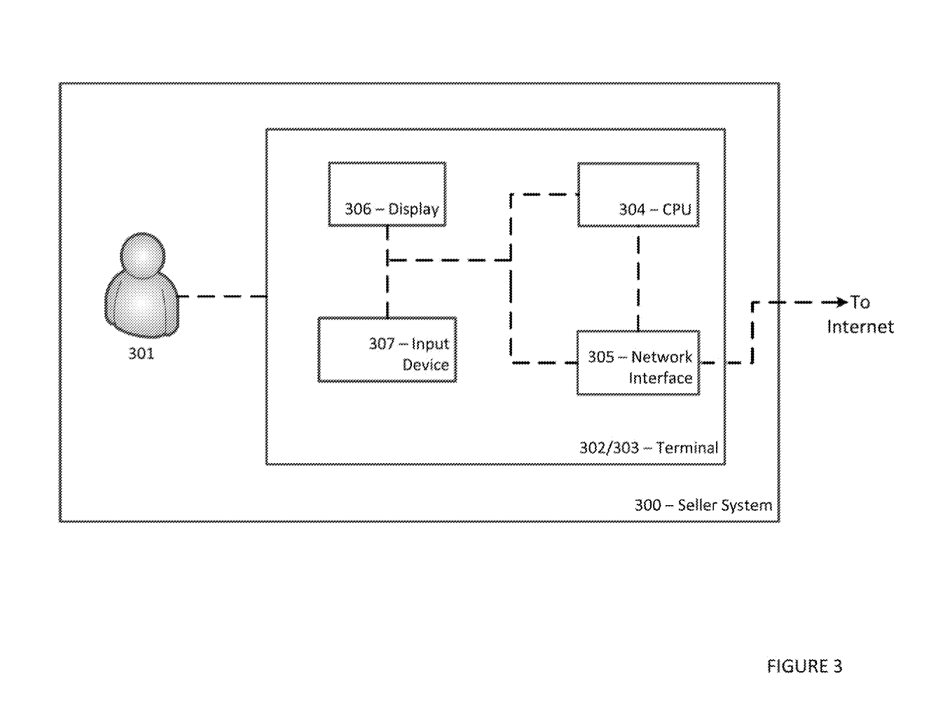

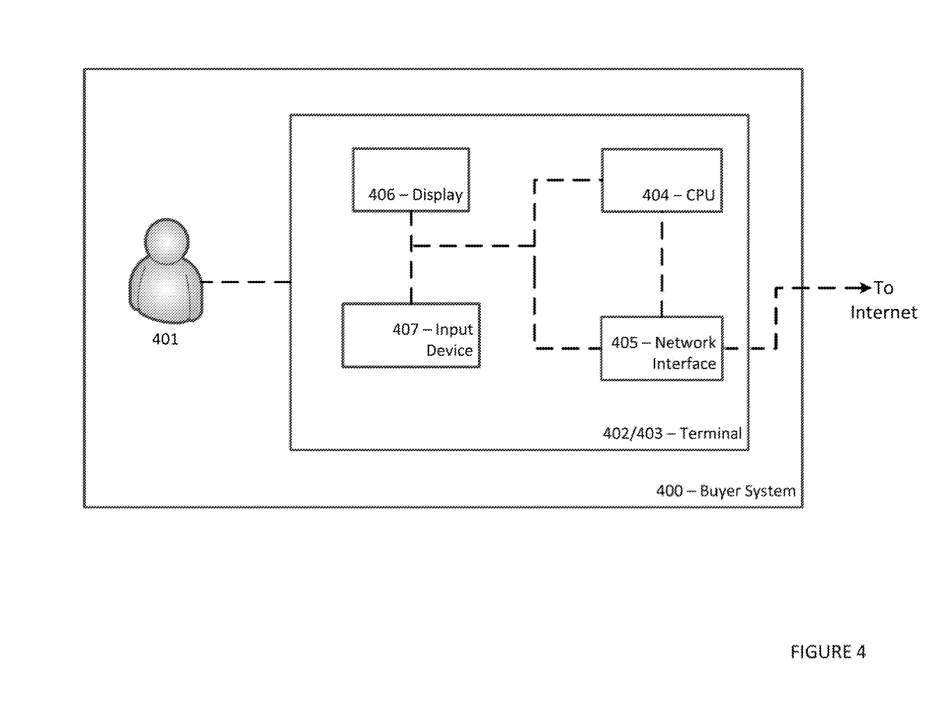

Referring to FIGS. 3 and 4, a seller system 300 and a buyer system 400 according to one embodiment of the present invention are illustrated. Each seller system 300 comprises a buyer 301 and at least one terminal 302/303. Similarly, each buyer system 400 comprises a buyer 401 and at least one terminal 402/403. Both the buyer 401 and the seller 301 may be referred to herein as a “user.” The at least one seller and buyer systems 300, 400 of the present invention are operably configured to connect to the LLT system 200, via a wired or wireless connection, access and search the liquor license database 205, and communicate with other seller and buyer systems 300, 400 via the LLT system 200. It should be noted that the LLT system 200 may be accessed by a plurality of seller and/or buyer systems 300, 400 at a single time. Further, although exemplified as comprising the above components, each of the buyer and seller systems 300/400 may comprise any number, more or less, of the components listed above.

The terminals 302/303/402/403 are configured to access the LLT system 200 for the seller and/or buyer 301, 401 upon request. For example, in one embodiment, the seller and buyer systems 300, 400 access the LLT system 200 using their personal computer 302, 402 and/or the mobile electronic device 303, 403 via a web portal of the LLT system 200. However, it should be noted that the invention is not so limited and in alternate embodiments the seller and buyer systems 300, 400 may access the LLT system 200 via other means, such as, but not limited to a thin-client portion of the LLT system 200 that resides the personal computer 302, 402 and/or the mobile electronic device 303, 403. Finally, it should be noted that either the personal computer 302, 402 or the mobile electronic device 303, 403 may be omitted from the seller and/or buyer systems 300, 400.

Each terminal 302/303 of the seller system 300 comprises a properly programmed processor 304, a memory device (not shown), a power supply (not shown), a video card (not shown), a display device 306, firmware (not shown), software (not shown), a network interface 305, and a user input device 307 (e.g., a keyboard, mouse and/or touch screen). It should be noted the processor 304 may be considered the processor of the seller system 300. Further, although exemplified as a singe terminal 302/303, the invention is not so limited and the seller system 300 may comprise any number of terminals 302/303. Additionally, although not exemplified, it should be understood that the processor 304 of the terminal 302/303 can have integrated memory. The properly programmed processor 304 of the terminal 302/303 is configured to effectuate the processes and functions described below, including, but not limited to the storage of data to the memory of the seller system 300, the display of the graphical user interfaces (GUI) generated by the LLT system 200 on the display device 306 for the seller 301, the transmission of user inputs from the seller 301 via the input device 307 to the other systems and modules of the system 100, and the transfer (transmission and receipt) of data from seller system 300 to the other systems and modules of the system 100.

Similarly, each terminal 402/403 of the buyer system 400 comprises a properly programmed processor 404, a memory device (not shown), a power supply (not shown), a video card (not shown), a display device 406, firmware (not shown), software (not shown), a network interface 405, and a user input device 407 (e.g., a keyboard, mouse and/or touch screen). It should be noted the processor 404 may be considered the processor of the buyer system 400. Further, although exemplified as a singe terminal 402/403, the invention is not so limited and the buyer system 400 may comprise any number of terminals 402/403. Additionally, although not exemplified, it should be understood that the processor 404 of the terminal 402/403 can have integrated memory. The properly programmed processor 404 of the terminal 402/403 is configured to effectuate the processes and functions described below, including, but not limited to the storage of data to the memory of the buyer system 400, the display of the graphical user interfaces (GUI) generated by the LLT system 200 on the display device 406 for the buyer 401, the transmission of user inputs from the buyer 401 via the input device 407 to the other systems and modules of the system 100, and the transfer (transmission and receipt) of data from buyer system 400 to the other systems and modules of the system 100.

The local control board system 500 is a local agency (either state, city or county) that controls the rules, regulations and transfers of liquor licenses within a particular jurisdiction (e.g. The California Department of Alcoholic Beverage Control (“ABC”) for a liquor license being transferred in California). The local control board system 500 comprises a server 501.

The server 501 comprises a properly programmed processor 503, memory 505, a network interface 504, a power supply (not shown), a video card (not shown), a display device (not shown), firmware (not shown), software (not shown), a network interface (not shown) and a user input device (not shown) (e.g., a keyboard, mouse and/or touch screen) all in operable communication with one another. It should be noted the processor 503 may be considered the processor of the local control board system 500. Further, although exemplified as a singe server 501, the invention is not so limited and the local control board system 500 may comprise any number of servers 501. Additionally, although not exemplified, it should be understood that the processor 503 can have integrated memory.

The memory 505 comprises at least a local control board database 502. According to one embodiment of the present invention, the local control board database 502 comprises listings of all outstanding liquor licenses within its jurisdiction, including their status (e.g., Active, Cancelled, Revoked or Surrendered) and the forms required to effectuate the transfer of a liquor license from a seller 301 to a buyer 401.

The properly programmed processor 503 of the local control board system 500 effectuates the performing of the processes and functions described below, including but not limited to, the storage of data to the memory 505 of the local control board system 500 and the transfer (transmission and receipt) of data from the local control board system 500 to the other systems (specifically, the LLT system 200) and modules of the system 100.

Further, according to one embodiment of the present invention, the local control board system 500 may comprise a plurality of individual offices, such that each office handles applications only for liquor license transfers to premises located within the counties in close proximity to the office.

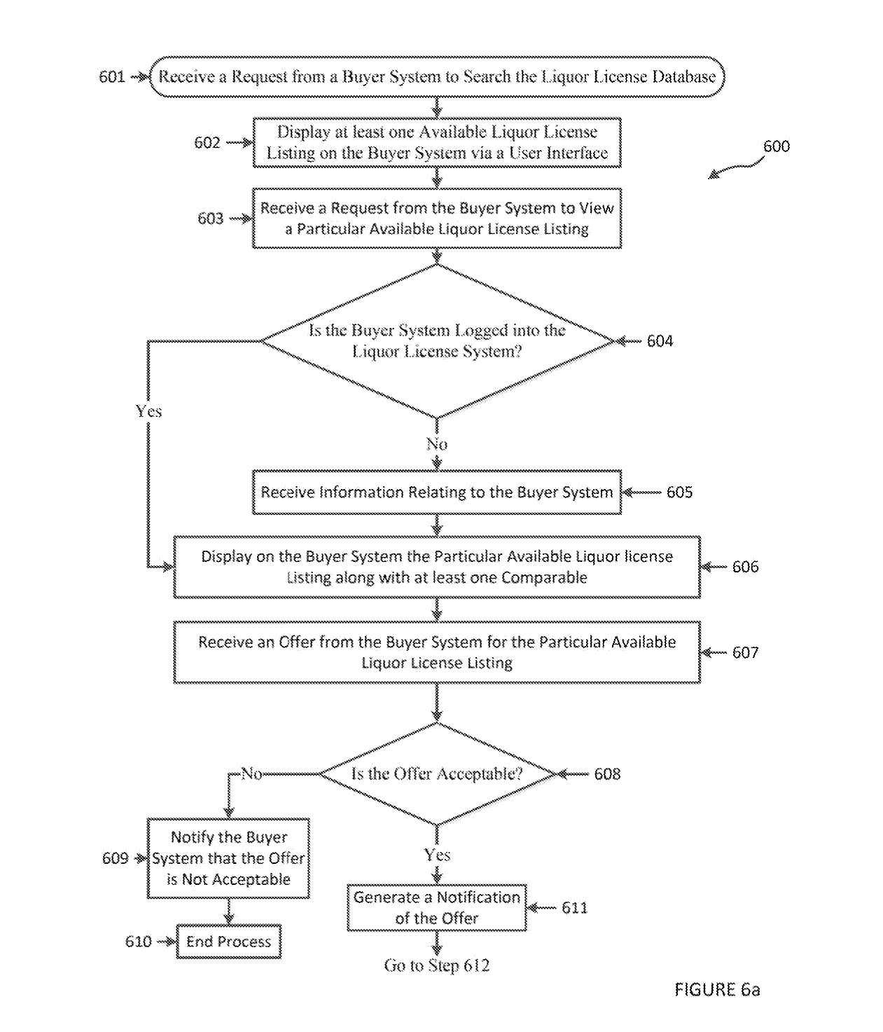

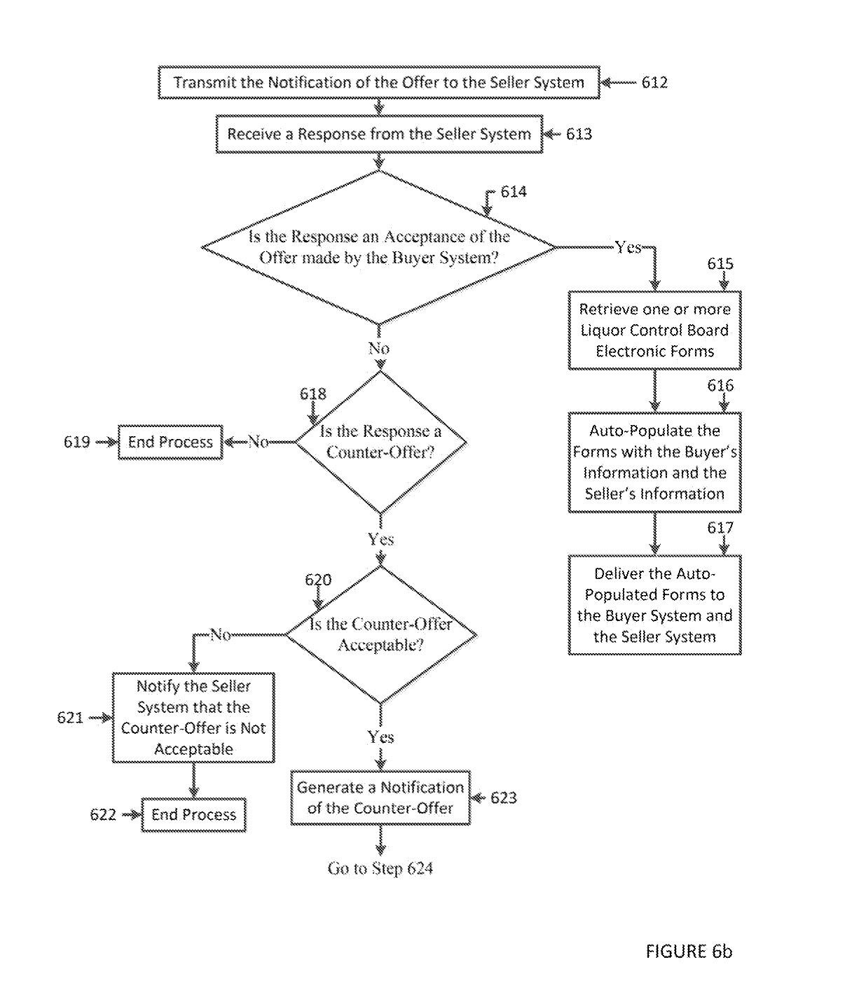

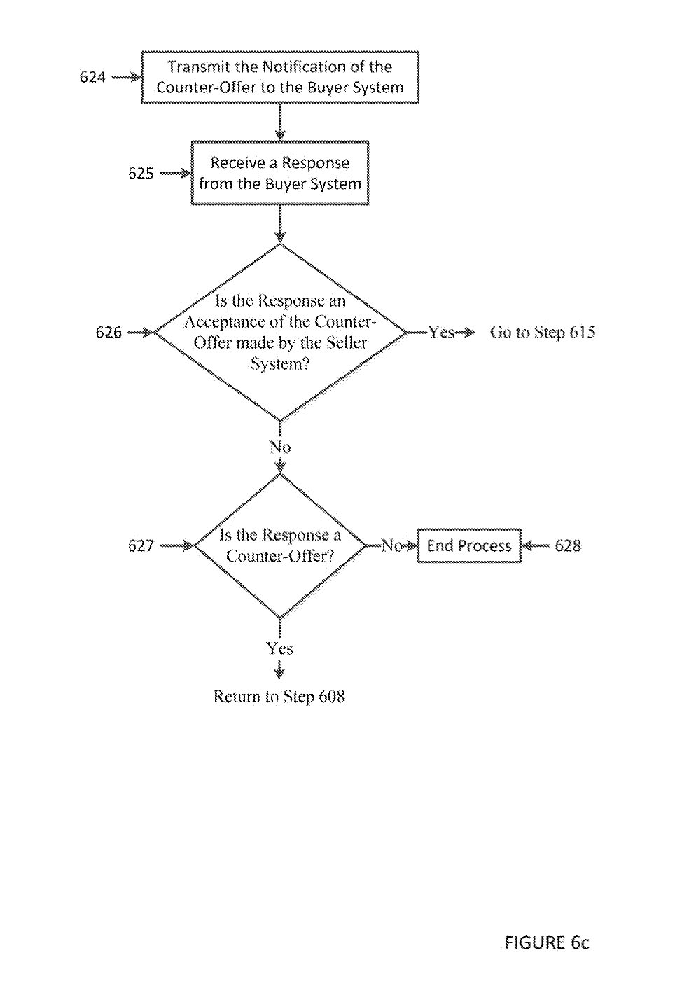

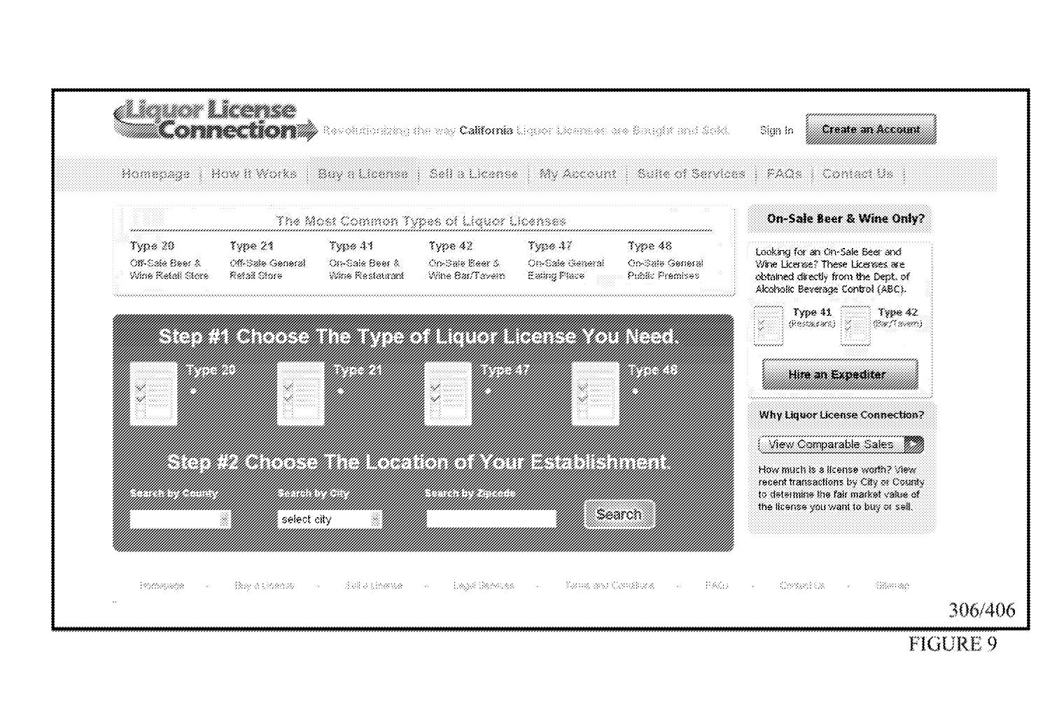

Turning to FIGS. 6a-6c, a method 600 of transferring a liquor license between a seller system 300 and a buyer system 400 according to one embodiment of the present invention is illustrated. The method begins when the buyer system 400 accesses the LLT system 200. According to one embodiment of the present invention, this may be done via a web portal of the LLT system 200 or a thin-client program of the LLT system 200 residing on the buyer system 400. After the LLT system 200 is accessed by the buyer system 400, the buyer system 400 generates and transmits a search request to the liquor license database 205 of the LLT system 200 for available liquor licenses (using the GUI shown in FIG. 9). In one embodiment of the present invention, the buyer system 400 first selects a specific state prior to beginning the search.

Although not exemplified, it should be noted that at any time during the process the buyer 401 may create an account with the LLT system 200. As discussed in more detail below, an account is required in order for a buyer 401 to view available licenses in a particular county, and to place an offer on a particular available liquor license. Nonetheless, it should be noted that the invention is not so limited and in alternate embodiments the buyer 401 may make an offer prior to creating an account with the LLT system 200.

As noted above, an available liquor license may be a liquor license posted by a seller system 300 or a Surrendered License that the LLT system 200. As discussed in more detail below, the lightings for surrendered licenses are received by the LLT system 200 via the LLT system 200 (and specifically the data script) requesting a transfer of data from the local control board system 500. Therefore, according to one embodiment of the present invention, the liquor license database 205 is also populated with listings of available liquor licenses via a transfer of data from a plurality of seller systems 300, along with a plurality of available Surrendered Licenses acquired by the LLT system 200 from the local control board system 500. Stated simply, the liquor license database 205 may comprise any number of available liquor licenses that are either posted by seller systems 300 or Surrendered Licenses uploaded from the local control board by the LLT system 200.

Prior to creating a listing for an available liquor license, each seller system 300 creates an account with the LLT system 200. The creation of a listing for an available liquor license entails the seller system 300 transferring data/information about the seller 301, such as the seller's name, phone number and email address. According to one embodiment, when the seller system 300 transfers such information, the LLT system 200 automatically generates and transmits an email message containing a web link which is sent to the seller's email address prompting the seller to click on the web link in order to verify that the seller system 300 truly wishes to create the account. Upon the seller system 300 activating the weblink, the LLT system 200 activates the seller system account. Thereafter, the seller system 300 transfers to the LLT system 200 the data/information relating to the seller's liquor license, including the name of the entity or individual that holds the license, the name which the entity or individual does business as (DBA), the licensed premises address, and the license type. Prior to creating the listing for the seller's license, the LLT system 200 automatically uploads additional information relating to the seller's license from the local control board system 500, including but not limited to, the officers/members/shareholders/partners of the licensee entity, when the license was issued, when the license expires, whether the seller has had any disciplinary history in connection with the license, and whether the license is currently in escrow. According to one embodiment of the present invention, this information is obtained by the LLT system 200 using the data script, which gathers and imports the related information.

After receiving all the information relating to the seller's liquor license, the administrator 201 of the LLT system 200 reviews the information to ensure that the seller 301 has the authority to sell the license. Thereafter, assuming the seller 301 is authorized to sell the license, the LLT system 200 generates an available liquor license listing with the received information and stores the listing in the liquor license database 205. According to one embodiment of the present invention, the LLT system 200 then transmits an email to the seller system 300 notifying them as to whether the listing is posted on the LLT system 200. Further, according to one embodiment, the listing is posted onto the Homepage of the website of the LLT system 200 under “Recently Posted Licenses.”

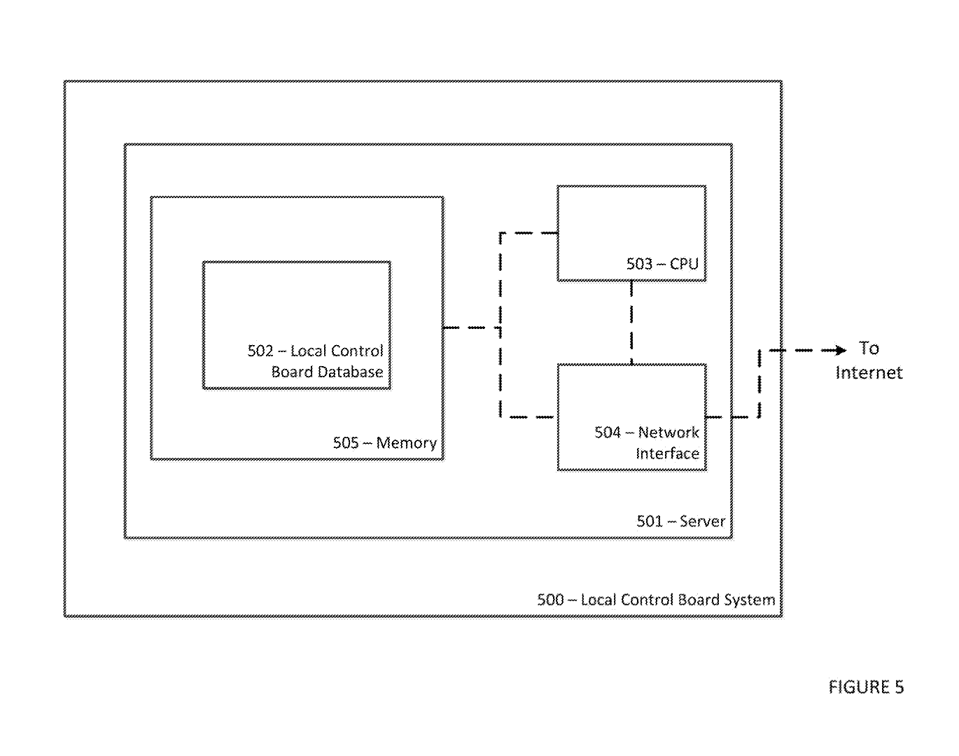

Referring back to FIGS. 6a-6c, when searching the LLT system 200, the buyer 401 may search for available liquor licenses based on any number of a plurality of different criteria, including but not limited to location (state, county, city, street and/or zip code) and the particular liquor license type (shown in FIG. 5). However, it should be noted that the search criteria is not limited to that which is listed above, and may include any other searching information relating to an available liquor license. After the LLT system 200 is access by the buyer system 400, the LLT system 200 will receive a request from the buyer system 400 to search the liquor license database 205 based on specific search criteria chosen by the buyer 401, thereby completing step 601. In one embodiment, the request received by the LLT system 200 is data relating to a desired liquor license.

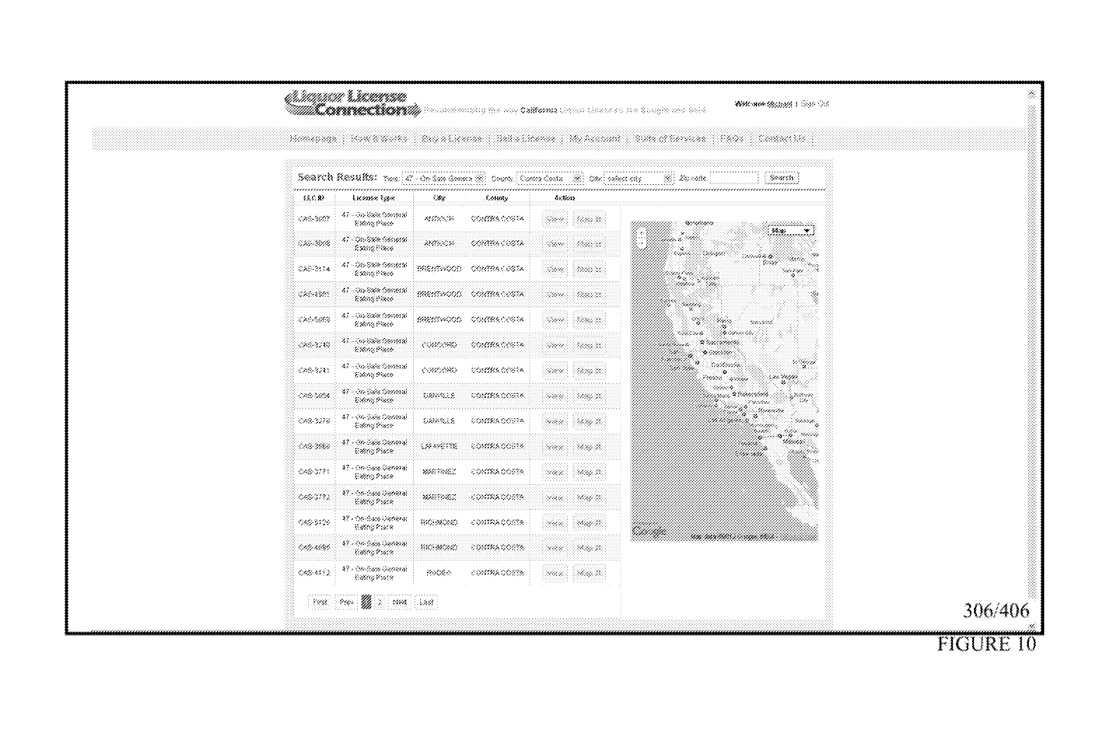

After receiving the request, the LLT system 200 searches the liquor license database 205 for listings of available liquor licenses that match the buyer system's search criteria. Thereafter, in step 602, the LLT system 200 displays at least one available liquor license listing on the display device 406 of the buyer system 400 via a user interface, such as that shown in FIG. 10. It should be noted that the at least one available liquor license listing displayed on the display device 406 of the buyer system 400 may be any combination of Surrendered Licenses and/or licenses posted by seller systems 300. As discussed above, the user interface may be a web portal or a thin client program of the LLT system 200.

Depending on the number of available liquor licenses that meet the buyer system's search criteria, the LLT system 200 creates a GUI and displays the listings of available liquor licenses on multiple pages, as can be seen at the bottom of FIG. 10. In the exemplified embodiment, the listings are sorted by their county, city and the license type. However, it should be noted that the invention is not so limited and in alternate embodiment the listings may be sorted by any other means.

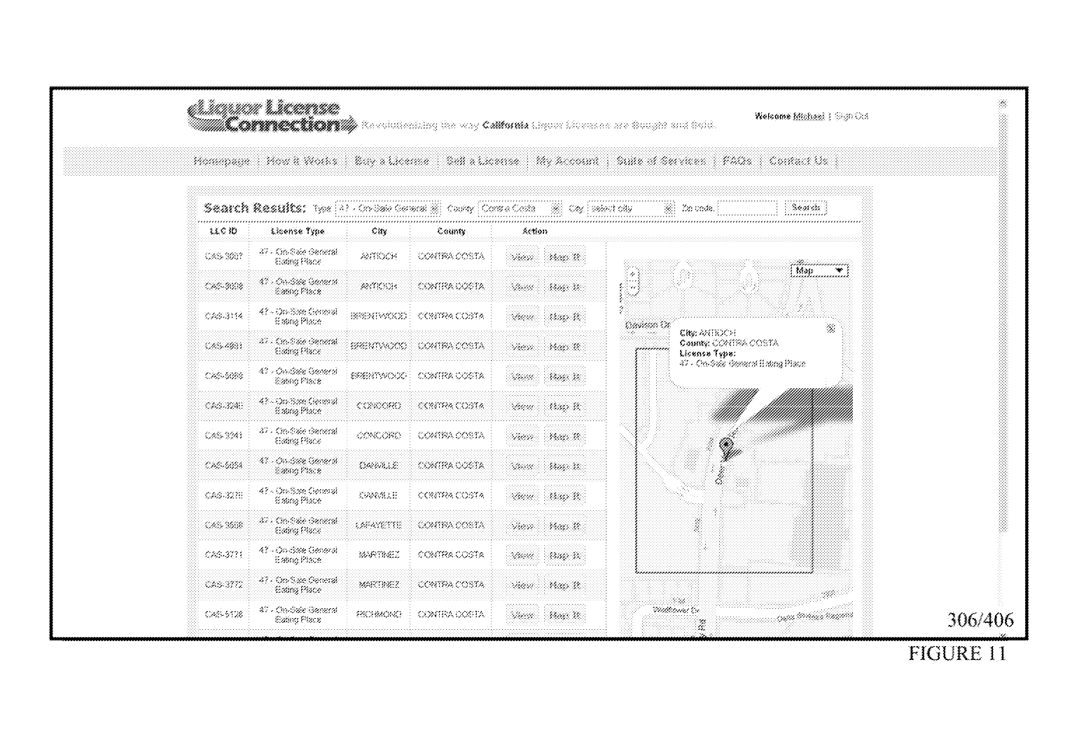

When presenting the available liquor license listings, the LLT system 200 may display to the buyer 401 with multiple actions, such as the ability to view the license and to map the license. If the buyer 401 chooses to map a particular available liquor license, the LLT system 200 generates a GUI that displays the location of the available liquor license on a map, as shown in FIG. 11. This allows the buyer 401 to view the exact location of the premises associated with each available liquor license, while still be presented with a display of the other available liquor licenses. This is also helpful for buyers 401 who are possibly looking to lease a premises that has already been licensed, or for buyers 401 who are looking to open a business in a city that has a policy against adding additional liquor licenses into that city.

The user can also elect to view the details of a specific listing (e.g., who holds the license, the business associated with the license, etc.). After the buyer system 400 chooses to view one of the available liquor licenses, the LLT system 200 receives the buyer system's request to view a particular license at step 603. Next, the LLT system 200 checks to see if the buyer system is logged into the LLT system 200, thereby completing step 604. According to the exemplified embodiment, in order for the buyer system 400 to view an available liquor license listing, the buyer system 400 should first be registered with the LLT system 200. If the buyer system 400 is not logged into the LLT system 200 at the time they are attempting to view a license and the buyer system 400 has not yet register with the LLT system 200, then the buyer system 400 should first transmit the buyer's information (e.g., first and last name, email address and phone number) to the LLT system 200 for registration with the LLT system 200, thereby completing step 605. Further, according to one embodiment, if the buyer system 400 is not logged into the LLT system 200, and the buyer system has previously registered with the LLT system, then the buyer system 400 must first transmits the buyer's login information (e.g. email address and password) to the LLT system 200.

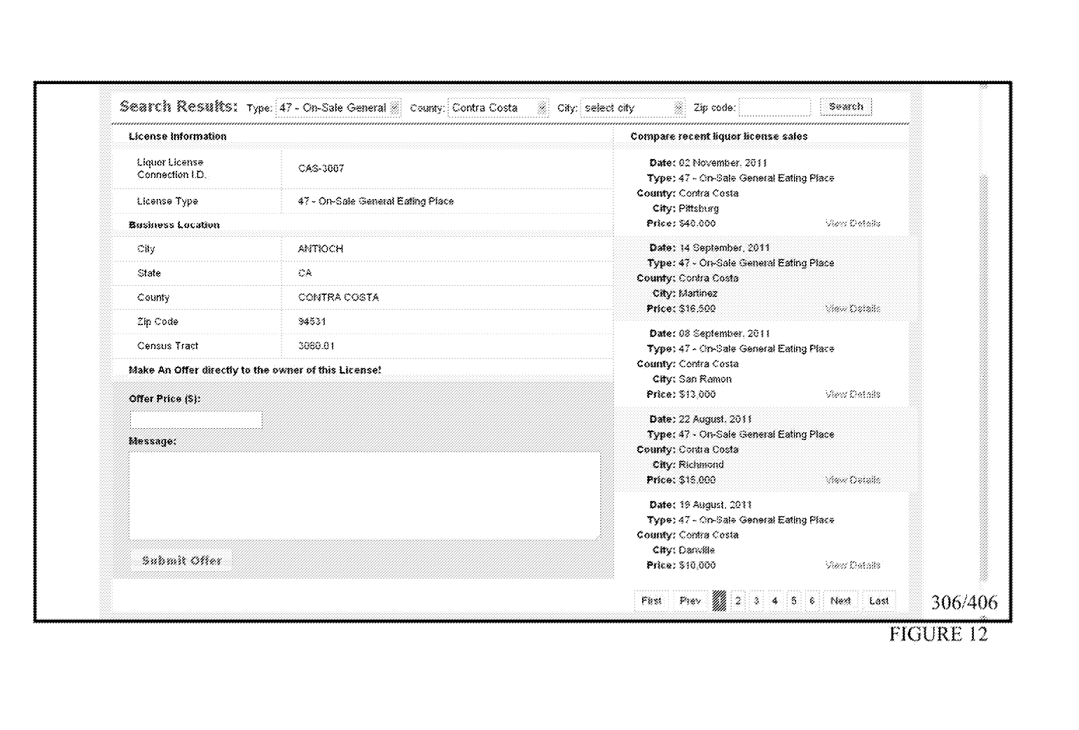

After the buyer system 400 is logged into the LLT system 200, the LLT system 200 generates a GUI that displays the particular available liquor license listing along with at least one comparable on the buyer system 400, thereby completing step 606 (and as shown in FIG. 12). As noted above, an available liquor license listing may be a Surrendered License or a liquor license offered for sale by a seller system 300. Further, a liquor license listing comprises information relating to the actual liquor license itself, such as, but not limited to the license number, license type, business name and business address of the available liquor license.

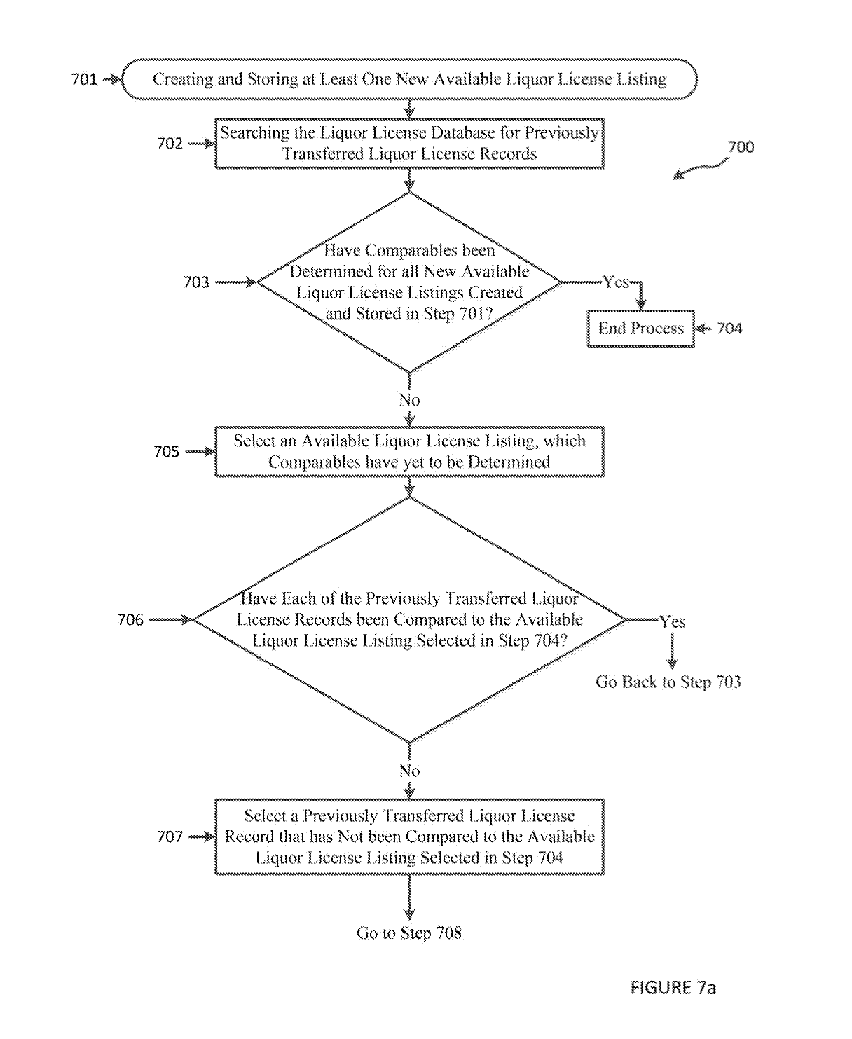

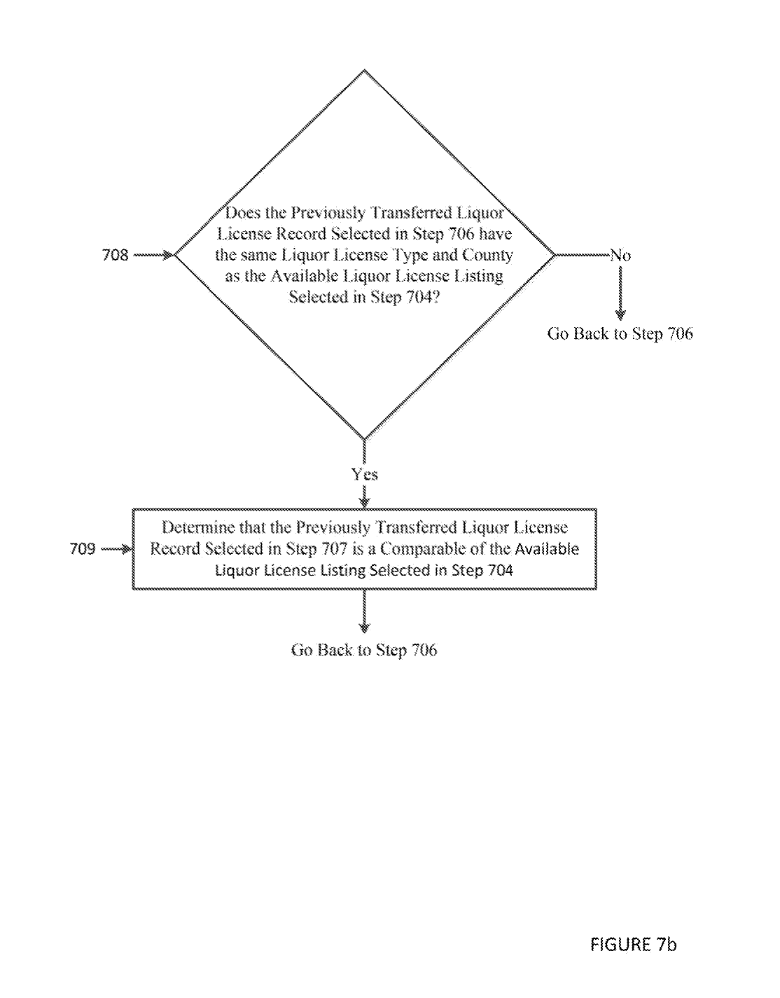

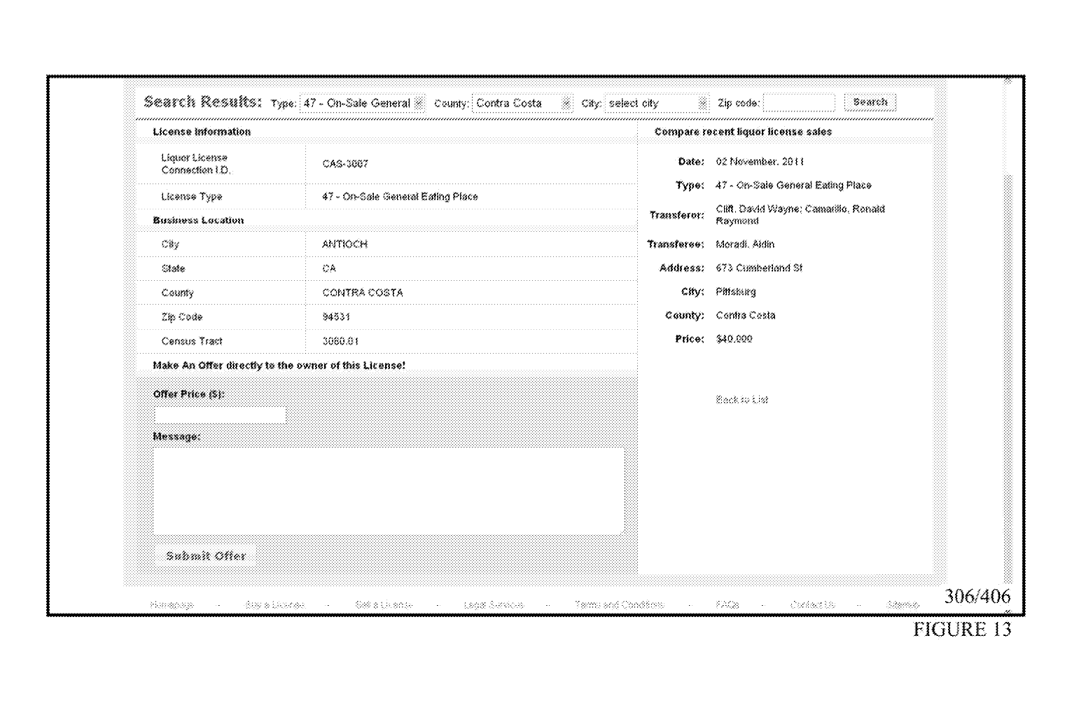

As shown in FIG. 12, the LLT system 200 generates a GUI that displays on the display device 406 of the buyer system 400 at least one comparable along with the available liquor license listing chosen by the buyer system 400. A comparable is a previously transferred liquor license record that is determined by the LLT system 200 to be similar to the available liquor license. Each previously transferred liquor license record is stored in the liquor license database 205 and comprises information relating to a previous transfer of a liquor license such as, but not limited to, the date the liquor license was transferred, the liquor license type, the county and city of the liquor license, and the consideration paid for the liquor license. How the LLT system 200 determines which previously transferred liquor license records are comparables for each available liquor license listing is explained in more detail below with reference to FIGS. 7a-7b. Further, as shown by the GUI of FIG. 13, the LLT system 200 generates a GUI that is presented to the buyer 401 via the display device 406 whereby the buyer 401 may simultaneously view the details or receive additional information relating to a particular comparable by selecting that comparable. This information is helpful to the buyer 401 when determining if and how much they should offer for a particular available liquor license.

Still referring to FIG. 6a, after the LLT system 200 displays the at least one comparable along with the available liquor license listing on the display device 406 of the buyer system 400, the buyer 401 has the option to make an offer on the available liquor license. The offer is a price that the buyer 401 is willing to pay for the available liquor license. It should be noted that, according to one embodiment of the present invention, the offer also includes a message for the seller 301 (using the GUT shown in FIGS. 12 and 13).

Thereafter, the LLT system 200 receives the offer from the buyer system 400 for the particular available liquor license, thereby completing step 607. Stated another way, the LLT system 200 receives offer data from the buyer system 400, the offer data comprising at least one of a price the buyer is willing to pay for the available liquor license and a message for the seller 301 of the available liquor license.

The LLT system 200 then determines if the offer is acceptable, thereby completing step 608. Stated another way, the LLT system 200 validates the offer. This determination is made to ensure that the offer is reasonable, the message is appropriate, and the integrity of the LLT system 200 is maintained. In one embodiment of the present invention, this determination is made objectively and subjectively by the administrator 201 of the LLT system 200, who compares the offer with the comparables and the market to ensure the offer is legitimate. For example, in one embodiment the administrator validates the offer if the offer recites a price that is within a predetermined threshold of the consideration paid for the all the comparables of the particular liquor license listings (or any sub-set of comparables). In another embodiment, the administrator validates the offer even if the offer is lower than a predetermined threshold if the supply of the type of license in question in the County is great but the demand is low. Therefore, it should be noted that the determination made by the administrator 201 may comprise objective and/or subjective criteria.

However, it should be noted that the invention is not so limited, and in alternate embodiments this determination may be automated by an executable computer program residing on the LLT system 200, the program objectively determining if the offer is within a predetermined threshold of acceptability (e.g., is the offer within 20% of the consideration paid for all comparable sold within the past year).

If the LLT system 200 determines that the offer is not acceptable, then the LLT system 200 generates and transmits a notification to the buyer system 400 indicating such, thereby completing step 609. Thereafter, the process is either ended, thereby completing step 610, or the buyer system 400 transmits another offer to the LLC system 200 for the available liquor license, in which case the method would return to step 607.

If the LLT system 200 determines that the offer is acceptable, then the LLT system 200 generates and transmits a notification of the offer to the seller system 300, thereby completing steps 611 and 612. Further, according to one embodiment, the LLT system 200 also generates and transmits a notification to the buyer system 400 indicating that the offer was acceptable and sent to the seller system 300. In the preferred embodiment, the notification of the offer is an email that is sent to the email addresses of the seller 301 and the buyer 401.

Stated another way, the LLT system 200 generates and transmits notification data that comprises the offer data, buyer information data, seller information data, and/or information relating to whether the offer was validated by the LLT system 200. However, it should be noted that the invention is not so limited, and in alternate embodiments, the notification may be a text message, phone call, a message received by the seller when they log into the LLT system 200 or any other alerting mechanism. Further, according to one embodiment, the seller 301 and the buyer 401 also receive a notification of the offer in their Account of the LLT system 200.

If the offer was placed on a liquor license added by a seller system 300, then the LLT system 200 notifies the seller 301 of the pending offer, as discussed above. However, if the offer was placed on a Surrendered License that has not yet been added to the seller system 300, then the LLT system 200 contacts the owner of the license by either sending an email, sending a physical letter or calling the owner of the license. In addition, in one embodiment, the LLT system 200 posts the license in the “Licenses Wanted” text box on the homepage of the LLT system 200 website in order to advise the general public that there is a potential buyer looking for his/her type of license. According to one embodiment, the LLT system 200 acquires the owner's contact information from the local control board 500 during the upload of information relating to the Surrendered License (discussed in more detail below with reference to FIG. 9). After the owner of the license has been contacted, if such owner is interested in selling the license, the owner creates an account on the LLT system 200 and the LLT system 200 associates the owner with the listing for the license that they own in the liquor license database 205, so that the owner (who is now considered a seller 301) can view the offer that was made on their liquor license by the buyer 401.

After the notification is transmitted to the seller system 300, the seller system 300 can then log into the seller system's account on the LLT system 200 to view the offer. From their account, the seller 301 can either accept the offer, reject the offer, or make a counter offer.

According to the exemplified embodiment, when the LLT system 200 receives a response from the seller system 300 in regards to the offer made by the buyer system 400 (thereby completing step 613), the LLT system 200 then determines if the response from the seller system 300 is an acceptance of the offer made by the buyer system, as exemplified by decision step 614. If the LLT system 200 determines that the response is an acceptance of the offer, then the LLT system 200 generates and transmits notification messages to both the buyer and seller systems 300, 400 that an agreement has been reached. Stated simply, if the LLT system 200 receives acceptance data from the seller system 300 in response to the buyer's offer, then the LLT system 200 generates and transmits notification messages to both the buyer and seller systems 300, 400 that an agreement has been reached.

In the preferred embodiment, the notification of the agreement is an email that is sent to the email addresses of the seller 301 and the buyer 401. The buyer 401 and seller 301 also receive a message to this effect in their account on the LLT system 200. Thereafter, the LLT system 200 continues to facilitate the transfer of the liquor license from the seller system 300 to the buyer system 400 by aiding in, among other things, the completion of the forms required by the local control board system 500 to effectuate the transfer.

After the agreement between the seller system 300 and the buyer system 400 has been reached, the LLT system 200 retrieves one or more electronic forms required to facilitate the transaction with the local control board system 500, thereby completing step 615. As discussed in more detail below, acceptance may be received by the LLT system 200 from the seller system 300 after the seller system 300 agrees to an offer presented by a buyer system 400, or from either the buyer or seller system 400, 300 after the buyer or seller system 400, 300 agrees to a counter-offer presented by the other party.

According to another embodiment, once an agreement is reached the LLT system 200 retrieves a web link, and delivers the link via email to the seller and buyer systems 300, 400. The email comprises a request to open the weblink and complete certain fields of information. Once this information is filled in by the seller 301 and buyer 401, the LLT system 200 pulls the information from the link and auto-populates the forms needed by the local control board 500 to effectuate the transfer of the liquor license.

However, in an alternate embodiment of the present invention, the seller's and buyer's information is previously stored in the liquor license database 205. According to one embodiment, upon signing up with the LLT system 200, the seller 301 and the buyer 401 enter their information. This information is stored in the liquor license database 205 and is used to auto-populate the local control board forms needed to effectuate the transfer of the liquor license.

In the preferred embodiment, the local control board forms are previously stored in the liquor license database 205, and thus the LLT system 200 retrieves the forms from the liquor license database 204 prior to auto-populating the forms with the seller's and buyer's information. In another embodiment, the LLT system 200 may reach out to the local control board system 500 to retrieve the forms or ensure that the stored forms are up-to-date. In an alternate embodiment, the LLT system 200 does not store the forms, but rather uploads the forms only upon the completion of a negotiation process between a seller 301 and buyer 401.

After the LLT system 200 retrieves the forms, the LLT system 200 auto-populates the forms with the buyer's information and the seller's information, thereby completing step 616. After the LLT system 200 auto-populates the local control board forms, the LLT system 200 stores the auto-populated forms to the liquor license database 205 of the LLT system 200. Further, if there are any inaccuracies in the forms, the LLT system 200 notifies the seller 301 and/or buyer 401.

After the LLT system 200 auto-populates the local control board forms, the LLT system 200 delivers the auto-populated forms to the seller and buyer systems 300, 400 for signature by the seller 301 and buyer 401 respectively, thereby completing step 617. Delivery of the forms may be electronically (via email or the user interface of the LLT system 200) or it may be physically (via the United States Postal Service or other mail carrier provider). Further, it should be noted that in alternate embodiments of the present invention, the LLT system 200 may digitally sign the local control board forms and deliver the forms directly to the local control board system 500 to effectuate the transfer of the liquor license from the seller system 300 to the buyer system 400.

Referring back to step 614, if the response received from the seller system 300 is not an acceptance of the offer, then the LLT system 200 determines if the response is a counter-offer, thereby completing step 618. If the response is not a counter-offer (e.g., only a rejection of the offer), then the process ends at step 619. Therefore, if the LLT system 200 receives rejection data from the seller system 300 in response to the buyer's offer, then the process ends.

However, if the response is a counter-offer, then the LLT system 200 determines if the counter-offer is acceptable, thereby completing step 620. This determination is similar to the determination made in step 608. Therefore, if the LLT system 200 receives counter-offer data from the seller system 300 in response to the buyer's offer, then the LLT system 200 determines if the counter-offer is acceptable (or in other words the LLT system 200 validates the counter-offer). Further, it should be noted that as used herein, the term counter-offer is one type of offer that may be made using the LLT system 200.

If the LLT system 200 determines that the counter-offer is not acceptable, then the LLT system 200 transmits a notification to the seller system 300 that their counter-offer is not acceptable, thereby completing step 621. Thereafter, the process ends at step 622, or the seller system 300 may transmit another counter-offer to the buyer system 400, in which case the process returns to step 613 (not illustrated). However, if the LLT system 200 determines that the counter-offer is acceptable, then the LLT system 200 generates and transmits a notification of the counter-offer to the buyer system 400, thereby completing steps 623 and 624.

Thereafter, the LLT system 200 receives a response to the counter-offer from the buyer system 400, thereby completing step 625. After the LLT system 200 receives the response, the LLT system 200 determines if the response is an acceptance of the seller's counter-offer, thereby completing step 626. If the response is an acceptance of the seller's counter-offer, then the process moves to step 615, described above. Stated simply, if the LLT system 200 receives acceptance data from the buyer system 400 in response to the seller's offer, then the LLT system 200 generates and transmits notification messages to both the buyer and seller systems 300, 400 that an agreement has been reached.

However, if the response is not an acceptance of the seller's counter-offer, then the LLT system determines if the response is a counter-offer made by the buyer system 400, thereby completing step 627. If the response is not a counter-offer (e.g., just a rejection), then the process ends at step 628. However, if the response is a counter-offer made by the buyer system 400, then the process returns back to step 608.

Stated simply, the process of steps 607-628 is a negotiation process between the buyer system 400 and the seller system 300 for the available liquor license owned by the seller with the LLT system 200 acting as a mediator and facilitator of the negotiation and resulting transaction. Further, it should be noted that the process of steps 623-627 is very similar to the process of steps 611-618, with the exception that in steps 623-627 the seller system 300 is making the offer (specifically, a counter-offer) and in steps 611-618 the buyer system 400 is making the offer.

Moreover, it should be noted that the method of FIGS. 6a-6c is just one non-limiting example of how the LLT system 200 of the present invention may be used to facilitate the transfer of a liquor license between a seller system and a buyer system. The present invention is not so limited and alternate methods of facilitating the transfer of a liquor license using the LLT system 200 are within the scope of the present invention.

Turning to FIGS. 7a-7b, a method 700 of determining comparables for a new available liquor license listing according to an embodiment of the present invention is illustrated. As noted above, a comparable is a previously transferred liquor license record that is similar to a particular available liquor license that is listed on the LLT system 200. According to one embodiment of the present invention, a comparable has the same general geographic location (e.g., county) as the available liquor license and is also of the same liquor license type. However, the invention is not so limited and in alternate embodiments a comparable may be similar is any other way to the available liquor license, such as, but not limited to, having the same city, being within the same census tract, being on the same street, being within a particular radius surrounding the available liquor license listing, or being having any other similar information that would relate to the value of the liquor licenses. Further, it should be noted that any combination of the above mentioned criteria may be used to define what a comparable is for a particular available liquor license listing.

When a buyer system 400 accesses the LLT system 200 and searches for available liquor licenses based on some criteria/constraints (e.g., license type, county and/or city), the LLT system 200 generates a GUI that displays to the buyer 401 via the display device 406 the search results. If the buyer system 400 chooses to “view” a particular available liquor license, information relating to the available liquor license is displayed along with a listing of comparables of the particular available liquor license (using the GUI shown in FIGS. 10 and 11). The comparables are displayed to the buyer 401 via the display device 406 in order to better educate them as to the fair market value of the available liquor license. Further, the comparables may be beneficial to the buyer 401 in deciding how much to offer for the particular available liquor license listed on the LLT system 200.

The method of determining comparables for a liquor license begins after the LLT system 200 receives information relating to a new available liquor license listing and/or receives information relating to liquor licenses that are about to be transferred in a particular county. According to one embodiment, the information relating to liquor licenses that are about to be transferred in a particular county is received by the LLT system 200 either by the LLT system 200 accessing and retrieving the information from the county recorder's office or through personal knowledge of the administrator. Further, in one embodiment, the information relating to liquor licenses that are about to be transferred in a particular county is uploaded to the LLT system 200 either through a .csv file or manually using features of the LLT system 200.

Referring to FIGS. 7a-7b, once the information is received, the LLT system 200 sorts the data by city and county, and/or creates at least one new available liquor license listing. Thereafter, the LLT system 200 stores the new listings in the liquor license database 205, thereby completing step 701. As noted above, each listing comprises information relating to an available liquor license, the information including, but not limited to, the license number, license type, business name and business address of the liquor license. In the case of available liquor licenses from the seller system 300, the LLT system 200 usually receives information relating to one new available liquor license at a time. However, in the case of Surrendered Licenses, the LLT system 200 may receive information relating to a plurality of new available liquor licenses from the local control board system 500 via the data script at one particular time.

After the LLT system 200 creates and stores at least one new available liquor license listing, the LLT system 200 searches or accesses the liquor license database 205 for previously transferred liquor license records, thereby completing step 702. As noted above, each previously transferred liquor license record comprises information relating to the previous transfer of a liquor license.

Prior to discussing how comparables are determined for each available liquor license listing, the processes and methods for populating the liquor license database 205 with previously transferred liquor license records (which are then determined as comparables) is described.

According to one embodiment of the present invention, the LLT system 200 populates the liquor license database 205 with a plurality of previously transferred liquor license records using both objective and subjective criteria. According to one embodiment of the present invention, the records of previously transferred liquor licenses are obtained via a combination of (i) the administrator's 201 direct involvement in liquor license transactions that take place in a particular state or county, and (ii) the LLT system 200 distilling and analyzing the sales data obtained by the LLT system 200 from a third party (e.g., the local control board system 500 or another third party that obtains public records from the offices of the county recorders in a state, and aggregates the sales data for the LLT system 200). However, in alternate embodiments of the present invention, the records may be obtained via just one of the methods described above and/or may be automated by the LLT system 200 using computer executable programs.

By way of example, in California when a seller 301 agrees to transfer a liquor license to a buyer 401, a Notice of Intended Transfer is recorded in the County in which the premises, of which the liquor license is associated, is located. One of the items of information contained in this Notice is the purchase price of the “Business.” This means that if a buyer 401 is purchasing alcoholic beverage inventory and furniture, fixtures and equipment relating to the alcoholic beverage business, this amount paid for these items is also included in the purchase price. As there is nothing on the recorded Notice that indicates what portion of the purchase price is allocated to the liquor license as compared to the alcoholic beverage inventory or to the furniture, fixtures and equipment, it is difficult to ascertain what the fair market value is for a liquor license in a particular city or county merely by looking at a series of Notices of Intended Transfer. Therefore, the determination of comparables requires the analysis of both objective and subjective factors by the LLT system 200.

After the records are obtained by the LLT system 200, they are analyzed using both objective and subjective criteria to ensure they provide an accurate reflection of the fair market value of the transferred liquor license prior to being stored in the liquor license database 205. As discussed in more detail below, a previously transferred liquor license record provides an accurate reflection of fair market value of the underlying liquor license if the consideration provided (e.g., the price paid) for the liquor license indicates that the transfer was an “arms length transaction,” did not include the transfer of any other property (e.g., building, inventory, etc.) or good will (e.g., existing business, customers, etc.) that greatly affected the consideration paid for the license, and was not influenced by the relationship between the parties (e.g. a transfer between family members or a transfer from an individual to that individual's trust), supply and demand in a certain county, or the existence of restrictions imposed by city officials on the transfer of licenses within a certain city or neighborhood (e.g. licenses that transfer in the North Beach area of San Francisco have a higher value than other parts of San Francisco due to various restrictions that have been placed on the transfer of new licenses into this area).

According to one embodiment of the present invention, the records are analyzed by the LLT system 200 to determine whether the underlying transaction accurately reflects the fair market value of underlying liquor license transferred. This determination may take into consideration any the following objective criteria of the previously transferred liquor license record: (i) the county in which the liquor license is located; (ii) the date the liquor license was transferred; (iii) the liquor license type; (iv) the transfer type of the liquor license (e.g., whether the transaction was a person-to-person transaction or a person-to-person and premises-to-premises transaction); (v) the premises location of the liquor license prior to transfer; (vi) the considered paid for the liquor license; (vii) whether the transfer of the liquor license was between related parties; (viii) the type of business associated with the liquor license (i.e. grocery store, hotel, convenience store, restaurant, etc.); and (ix) whether the purchase price (consideration) clearly reflects that property or good will (e.g., a business, a building, a store name, alcohol inventory or furniture, fixtures and equipment) was included in the sale, consideration paid for previously transferred licenses of this type, supply and demand in the County, local restriction on traffic, etc.

Further, the LLT system 200 uses the following subjective criteria when determining whether a previously transferred liquor license record accurately reflects the fair market value of the underlying liquor license transferred: (i) the influence that the relationship of the parties had on the transfer, if the transfer was between related parties; (ii) the influence of the transaction type; (iii) whether and to what degree the consideration reflects that property or good will was transferred contemporaneously with the liquor license; (iv) how the geographic area is defined when comparing the record to other records; (v) how close the sales price (consideration) of the record is to the median sales price in the same geographic area; (vi) the market trend for the particular geographic area for that particular type of liquor license; and (vii) the supply and demand of a particular geographic area for a specific liquor license type.

It should be noted that, according to one embodiment of the present invention, the determination is done using both objective and subjective criteria. Further, it should be understood that the criteria listed above is a non-limiting list, and that any other objective or subjective criteria relating to liquor licenses may be used by the LLT system 200 when determining whether a record of a previously transferred liquor license represents the fair market value for the liquor license.

According to one embodiment of the present invention, this analysis is done entirely by the administrator 201 of the LLT system 200 utilizing their experience with hundreds of liquor license transactions. According to another embodiment of the present invention, the analysis is done entirely by a computer executable program residing on the LLT system 200. Further, according to yet another embodiment of the present invention, the analysis is accomplished via a combination of the administrator 201 and computer executable programs residing on the LLT system 200.

Once the determination is made regarding which of the previously transferred liquor licenses are considered a fair representation of the fair market value of the underlying liquor license, information relating to those plurality of previously transferred liquor licenses are stored in the liquor license database 205 as records, and sorted by location (country, city or state) and date of transfer. Further, it should be noted that the liquor license database 205 is periodically updated (e.g., daily, weekly, or monthly) with additional records of transferred liquor licenses to ensure that the LLT system 200 has an up-to-date and accurate representation of the liquor license market.

For example, one embodiment where the LLT system 200 uses a computer program to upload the previously transferred liquor license records onto an Excel® spreadsheet, then through a Dashboard interface of the LLT system 200, the administrator 201 can click on a “Comps” tool, and click on “Import from .csv”. The records are then automatically uploaded to the LLT system 200, which automatically sorts the previously transferred liquor license records by data, county, and license type, and displays the previously transferred liquor license records on the LLT system 200. According to another embodiment of the present invention, the administrator 201 goes to the Dashboard, click on “Comps”, click on “Add New”, and then manually adds a previously transferred liquor license record to the liquor license database 205. Thereafter, the LLT system 200 automatically sorts the individual previously transferred liquor license records by date, County, and license type, and adds the previously transferred liquor license records to the LLT system 200. However, as noted above, the invention is not so limited and the liquor license database 205 may be populated using other manual or automatic methods.

In addition, it is very difficult and time consuming for a member of the public to obtain sufficient amounts of data from a County Recorder's office to accurately ascertain the fair market value of a liquor license in that particular geographic area. Therefore, even though the purchase price of the liquor license may be public information, the data that is currently available to the members of the public is not easily accessible and is not always helpful in determining the fair market value of just the liquor license in the particular geographic area due to the fact that the data may contain information that must be distilled out prior to determining whether it is a good comparable.

Referring back to FIG. 7a, the method 700 of determining which of the previously transferred liquor license records are comparables for a particular available liquor license listing is illustrated. After accessing the liquor license database 205, the LLT system 200 determines if comparables have been determined for each of the at least one new available liquor license listings, thereby completing step 703. If the LLT system 200 has not determined comparables for each of the new available liquor license listings, then the process moves forward to step 705. However, if the LLT system 200 has determined comparables for all new available liquor license listings, then the process ends at step 704.

Assuming that there have been new available or previously transferred liquor licenses records added, the LLT system 200 has not determined comparables for all new available liquor license listings and the LLT system 200 selects an available liquor license listing in which comparables have yet to be determined, thereby completing step 705. As discussed in more detail below, after selecting a new available liquor license listing, the LLT system 200 checks each of the previously transferred liquor license records to determine if they are a comparable.

In step 706, the LLT system 200 determines whether each of the previously transferred liquor license records have been compared to the new available liquor license listing. If every liquor license listing has been compared, then the process goes back to step 703. If there are previously transferred liquor license records that have not been compared to the new available liquor license listing, then the process moves to step 707 and the LLT system 200 selects a previously transferred liquor license record that has not yet been compared to the new available liquor license listing.

Then in step 708, the LLT system 200 determines whether the previously transferred liquor license record is a comparable for the new available liquor license listing. In the exemplified embodiment, the previously transferred liquor license record is a comparable if the previously transferred liquor license record has the same liquor license type and county as the new available liquor license listing, thereby completing step 309.

However, it should be noted that the invention is not so limited, and in alternate embodiments the determination of whether a previously transferred liquor license record is a comparable may comprise a comparison of different elements of the listing and record. For example, comparables may be determined based on a broader or more specific geographic location depending on the number of previously transferred liquor license records available for a particular geographic location. Moreover, the comparison may take into consideration subjective as well as objective information. For example, the determination may comprise a comparison of the number of other licenses within a set area surrounding the liquor licenses, a comparison of the proximity of the licenses to their closest surrounding licenses, etc.

If the previously transferred liquor license record is not determined to be a comparable for the particular available liquor license listing, then the process returns back to step 706. However, if the previously transferred liquor license record is determined to be a comparable for the particular available liquor license listing, then the LLT system 200 associates the previously transferred liquor license record with the particular available liquor license listing such that when the particular available liquor license listing is subsequently searched via the user interface of the LLT system 200, the previously transferred liquor license record will be displayed contemporaneously with the particular available liquor license listing as a comparable to aid the potential buyer or seller in assessing the fair market value of the available liquor license.

Thereafter, the process returns back to step 706. Once returning the step 706, the process repeats itself, determining whether each and every previously transferred liquor license record stored in the liquor license database 205 is a comparable for the particular available liquor license listing.

Turning to FIG. 8, a method 800 of populating the liquor license database with Surrendered Licenses according to one embodiment of the present invention is illustrated. As discussed in more detail below, the LLT system 200 uses a data script to access, search and upload information from the local control board system 500. However, it should be noted that the invention is not limited to the use of a data script.

A Surrendered License is a liquor license that is currently owned by an individual or corporation but is not actively being utilized or currently inactive. For example, a license may be deemed “surrendered” when the licensee notifies the local control board that the licensee's business activities involving the sale of alcoholic beverages have ceased, but that the licensee desires to retain the license for purposes of selling it or starting a new business at a later date.

Referring to FIG. 8, with the use of the data script the LLT system 200 searches the local control board system 500 for Surrendered Licenses. The data script is a computer executable program that reaches out to the local control board system 500 and searches its databases and/or web pages for liquor licenses that have a status of “Surrendered,” in step 801. It should be noted that the term “surrendered” is given by some states (e.g., California) to designate inactive liquor licenses, while other states (e.g., New Jersey) term these licenses “inactive.” As used herein, and as noted above, the term “Surrendered” is to be understood to include all types of inactive or surrendered liquor licenses.

The LLT system 200 searches the local control board system 500 on a periodic basis using the data script. For example, in New Jersey, the list of inactive licenses may be purchased from the local control board. According to one embodiment of the present invention, the periodic basis is a daily basis. However, the invention is not so limited and in alternate embodiments the periodic basis may be weekly, monthly or any other periodic basis as required by the LLT system 200.

In accordance with one embodiment of the present invention, the data script sends a robot to the local control board website or database and searches through each webpage or database of the local control board system 500 that lists liquor licenses by geographic area (e.g., city, county, zip code, etc.). The robot then gathers information and only uploads to the LLT system 200 the information relating to liquor licenses that have been Surrendered, omitting data regarding Active, Cancelled, Revocation Pending, or liquor licenses having any other status other than Surrendered.

Further, in accordance with one embodiment of the present invention, the data script is programmed to run automatically each day, but can be run manually by the Administrator 201 of the LLT system 200. It should be noted that any or all of the Administrator functions described herein may be performed manually by an individual or set to be automatically performed by the LLT system 200 via computer executable programs.

After searching the local control board system 500, the LLT system 200 determines if there are Surrendered Licenses on the local control board system 500 that have not been uploaded to the liquor license database 205, thereby completing step 802. If there are no new Surrendered Licenses on the local control board system 500, then the process moved to step 806 (discussed in more detail below). However, if there are new Surrendered Licenses on the local control board system 500, then the LLT system 200 uploads information relating to the new Surrendered Licenses, thereby completing step 803. According to one embodiment of the present invention, the information relating to each of the plurality of Surrendered Licenses comprises the name of the entity that holds the liquor license (e.g., owner contact information), the liquor license type, the name of the businesses associated with the liquor license, and the premises address of the business associated with the liquor license.

After uploading information relating to the new Surrendered Licenses, the LLT system 200 generates available liquor license listings for each of the new Surrendered Licenses, thereby completing step 804. According to one embodiment, this is done based on city, County, and license type. Then the LLT system 200 stores each of the new available liquor license listings in the liquor license dataset 205, thereby completing step 805. As noted above, each available liquor license listing comprises information relating to the underlying liquor license itself, such as, but not limited to the license type and the business name and premises address of the available liquor license.

After each of the new available liquor license listings are stored in the liquor license database 205, the LLT system 200 uses the data script to search the local control board system 500 for liquor licenses that are not longer surrendered in step 806. Stated simply, the data script searches for liquor licenses that previously had a status of “Surrendered”, and consequently may have been uploaded and stored as available listings in the liquor license database 205, but now have a different status (e.g., Active, Cancelled, Revoked or Surrendered). Since these liquor licenses are no longer surrendered, they are removed from the liquor license database 205 in order to keep the LLT system 200 up to date. However, in alternate embodiments, the LLT system 200 may keep these liquor licenses on a separate database of the LLT system 200 for searches or other uses by the administrator 201, the seller system 300 or the buyer system 400.

Still referring to FIG. 8, the LLT system 200 determines if there are any licenses on the local control board system 500 whose status was changed from “Surrendered” in decision step 807. If the LLT system 200 determines that there are licenses who status has changed, then the LLT system 200 checks to see if there is a corresponding liquor license listing for the license stored in the liquor license database 205 at step 809. If there is a corresponding liquor license listing stored in the database 205, then the LLT system 200 removes that listing from the liquor license database 205, thereby completing step 810. However, if there are no liquor licenses on the local control board system 500 whose status has changed from “Surrendered,” then the process ends at step 808.

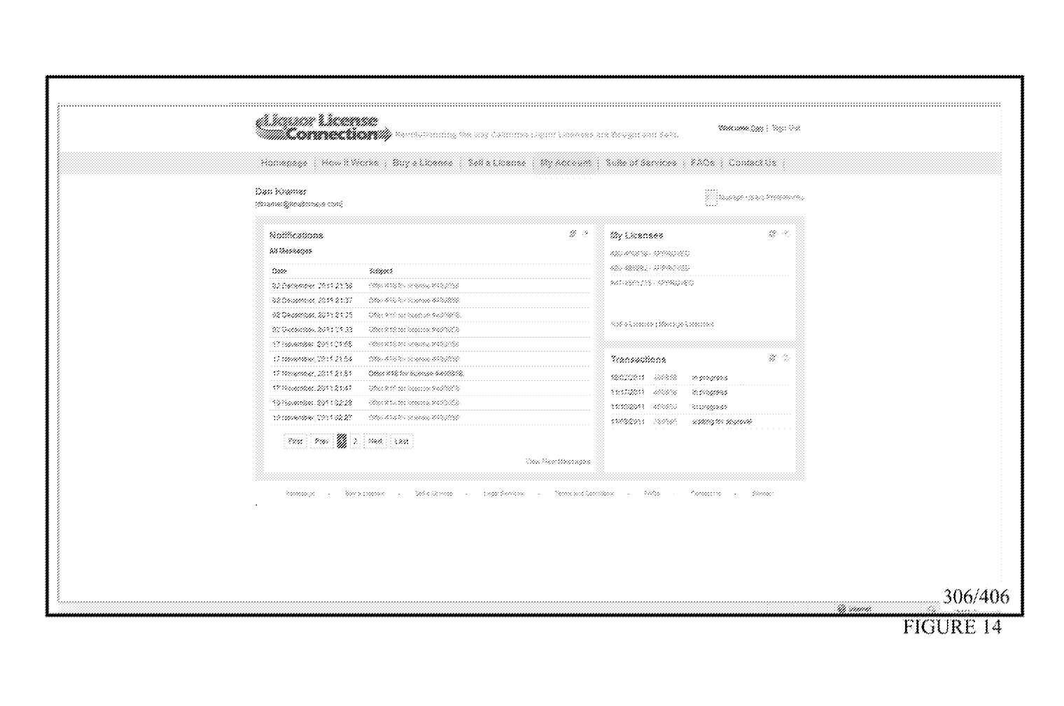

Referring to FIG. 14, a screen shot from a user interface for a particular seller or buyer's account of the LLT system 200 according to one embodiment of the present invention is illustrated. According to one embodiment of the present invention, the user interface of the LLT system 200 comprises a list of all messages in date order that a seller or buyer 301, 401 has received from the administrator 201 or another seller or buyer 301, 401. For example, a notification may be automatically generated and delivered to a seller 301 when a license is added to their account, or when the seller/buyer 301, 401 has made an offer on a license or received an offer on a license. Additionally, a seller 301 may view the licenses they have listed for sale on the LLT system 200.

Further, according to one embodiment, the administrator 201 can also send notifications to the seller/buyer 301, 401 through the user interface regarding the status of a pending transfer (e.g., escrow has been opened, the application has been filed with the local control board 500, the LLT system 200 is still waiting for signed documents from the buyer 401 or seller 301, etc.), or any other information that the administrator 201 deems to be beneficial or informative relating to the liquor license transfer process.

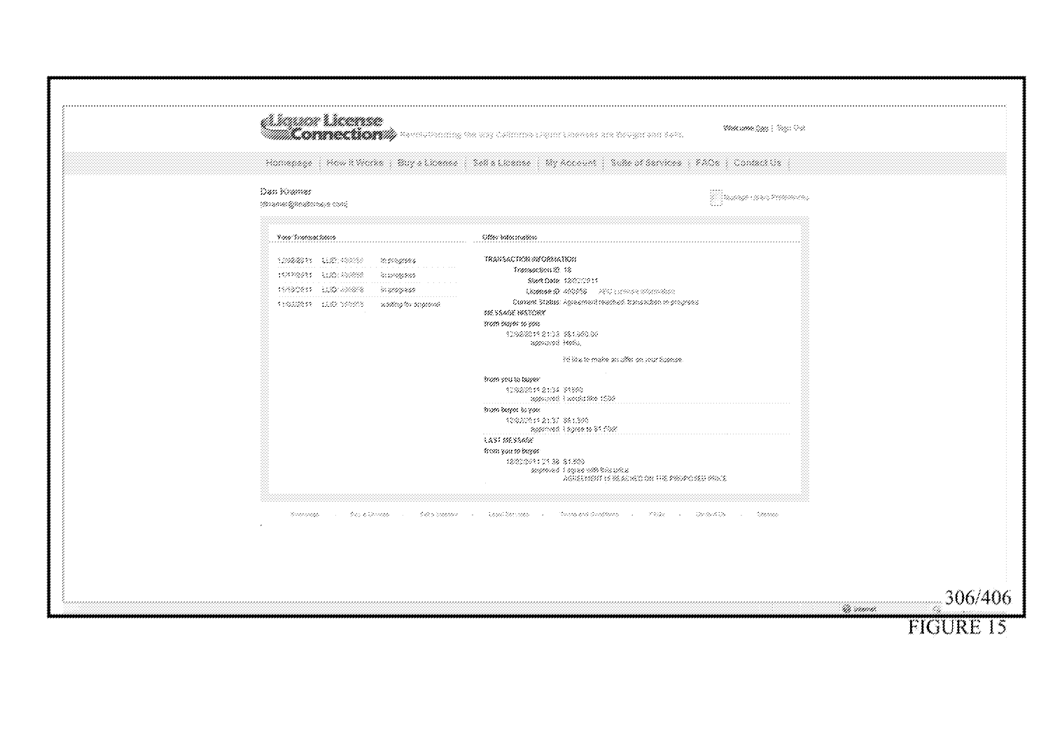

Moreover, it should be noted that the LLT system 200 may also be used to track the status of a transaction. Therefore, if a seller 301 or buyer 401 is involved in an ongoing negotiation for a liquor license, they may track the status of their transaction using the LLT system 200 (as shown in the GUI of FIGS. 14 and 15).

Referring to FIG. 15, a GUI generated by the LLT system 200 displayed on a display device 306/406 presents transaction information relating to a particular liquor license of the LLT system 200 according to one embodiment of the present invention. As shown in FIG. 15, a user (seller or buyer 301, 401) can review all of the messages sent and received in connection with the acquisition or disposition of a particular liquor license. Further, the LLT system 200 may list all of the licenses that a seller/buyer 301, 401 holds and the details relating to the license (e.g., license number, premises address, expiration date). This is a useful tool for companies that hold multiple licenses within a particular state and desire an easy way to keep track of all of their licenses.

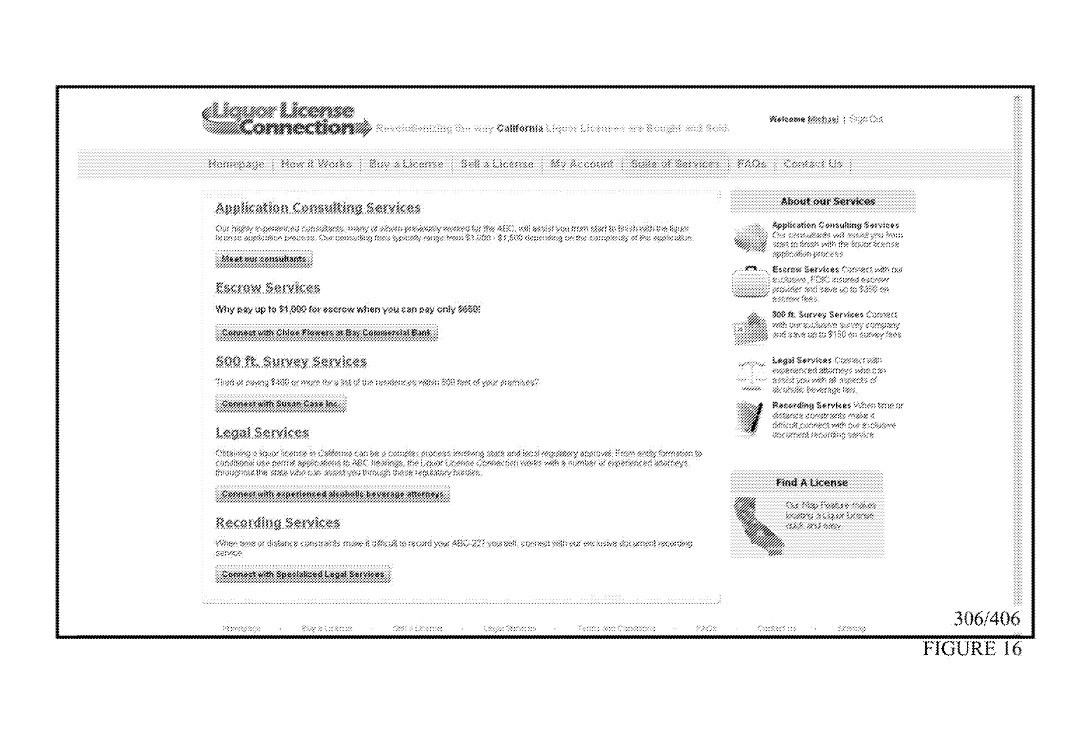

Referring to FIG. 16, a GUI generated by the LLT system 200 and displayed on a display device 306/406 presenting a suite of services provided by the LLT system 200 according to one embodiment of the present invention is illustrated. As discussed in more detail below, the LLT system offers a plurality of additional survives to aid in the facilitation of the transfer of a liquor license in each particular state in an effort to be a “one stop shop” for the transfer of liquor licenses.

As described in more detail below and in accordance with one embodiment of the present invention, the LLT system 200 is configured to allows users (seller and buyer systems 300, 400) to connect with third party service providers who provide expediting, escrow, legal, survey, recording, and/or publication services to aid in the facilitating of the transfer of a liquor license.

In an alternate embodiment of the present invention, via the LLT system 200, seller and buyer systems 300, 400 in a particular state can hire retired, senior level ex-employees of the local control board system 500 based in each geographic region of the state to help expedite a liquor license application through the transfer process.

Further, according to an alternate embodiment of the present invention, seller and buyer systems 300, 400 can communicate or consult with an expediter by selecting the county in which the premises of the liquor license is located, and then submit a message on the LLT system 200 to a particular expediter. This message is received by the LLT system 200 and is then delivered to the appropriate expediter via email. The expediter can then email the seller or buyer system 300, 400, or the administrator can send a notification through the LLT system 200.

According to one embodiment of the present invention, the LLT system 200 offers discounted escrow services to users to facilitate the transfer of a liquor license. In some states, such as California, the consideration paid for a liquor license is held in escrow (with a few exceptions) until the local control board system 500 approves the transfer of the liquor license to the buyer 401. Therefore, sellers and buyers 301, 401 of the LLT system 200 can open an escrow account with a Federal Deposit Insurance Corporation (FDIC) insured bank at a heavily discounted price or consult with an escrow agent at the bank by completing forms provided by the LLT system 200. According to one embodiment, the forms are received by the LLT system 200 after being completed by the seller and/or buyer 301, 401, and then delivered to the bank. This may be done manually by the administrator 201 or may be done automatically by computer executable programs residing on the LLT system 200.

For example, in California when a liquor license is being transferred to a premises that has not previously been licensed, the transferee is required to send a notice to all of the residents within 500 feet of the premises. According to one embodiment of the present invention, seller and buyer systems 300, 400 of the LLT system 200 can consult with or hire a surveyor at a heavily discounted rate to complete a survey listing all of the residents within 500 feet of the premises to be licensed using the LLT system 200. The forms are stored in the liquor license database 205. Upon completion of the forms, the LLT system 200 delivers the forms to the survey company.

In an alternate embodiment of the present invention, the seller and buyer systems 300, 400 of the LLT system 200 can consult with or contact law firms that specialize in all aspects of alcoholic beverage law by selecting one of a plurality of legal issues from the user interface of the LLT system 200 and filling out the appropriate forms that are saved in the liquor license database 205. Upon the forms being completed, the LLT system 200 delivers the forms to the appropriate law firm.

According to one embodiment of the present invention, when an application is filed to transfer a liquor license from a seller system 300 to a buyer system 400, a Notice of Intended Transfer needs to be recorded in the County in which the liquor license premises is located. Via the LLT system 200, sellers and buyers 301, 401 can consult with or contact a recording service who can record the notices of intended transfer in any county throughout the state. This is done by completing the appropriate forms using the LLT system 200, the forms being saved in the liquor license database 205. Upon completion of the forms, the LLT system 200 delivers the forms to the recording service.

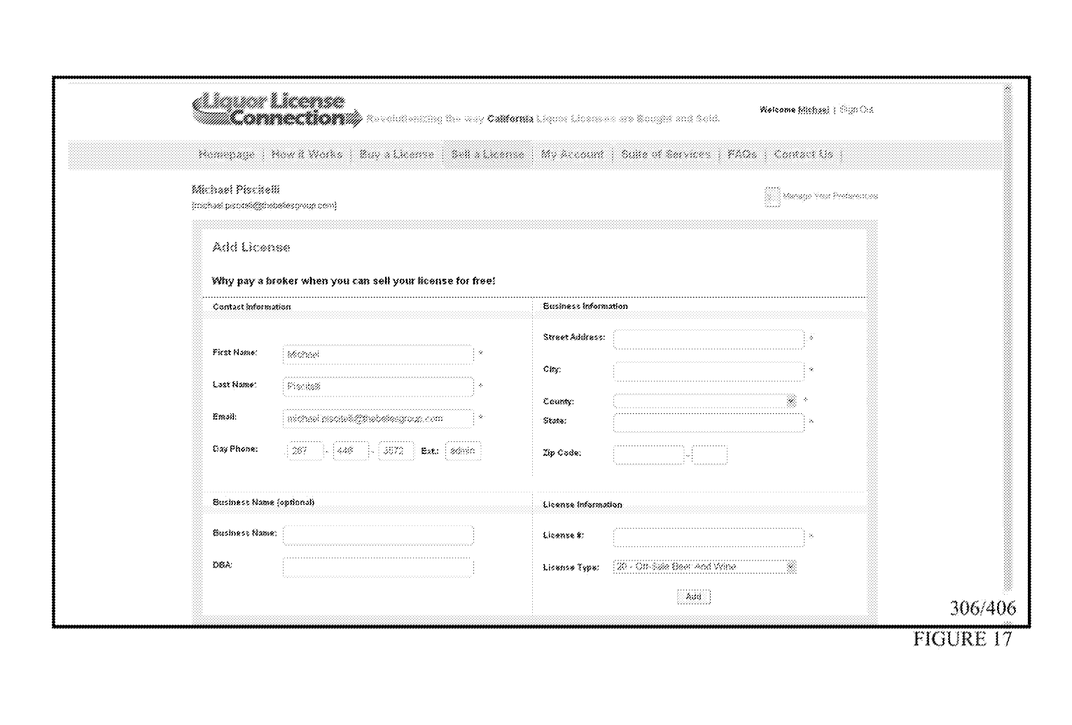

Referring to FIG. 17, a GUI generated by the LLT system 200 and displayed on the display device 406 of the seller system 400 is illustrated. As noted above, a seller 401 may add a new available liquor license to the liquor license database 205 of the LLT system 200. The seller 401 enters information such as their name, email, phone number, the liquor license information (license number and type), information relating to the business associated with the liquor license, and the business name into the GUI using their input device 407. Next, the LLT system 200 receives the information, generates an available liquor license listing with the information, and stores the available liquor license listing in the liquor license database 205. After storing the available liquor license listing, the LLT system 200 may determine, associate, and store comparables for the available liquor license listing in the liquor license database 205. Thereafter, if a user searches the liquor license database 205 using the LLT system 200, the available liquor license may be presented or displayed if the search criteria matches its information. Moreover, the display will also simultaneously display the comparables of the available liquor license to aid the user in determining the fair market value of the license.

While the embodiment of the present invention has been described with reference to the accompanying drawings, it can be understood by those skilled in the art that the present invention can be embodied in other specific forms without departing from its spirit or essential characteristics. Therefore, the foregoing embodiments and advantages are merely exemplary and are not to be construed as limiting the present invention. The present teaching can be readily applied to other types of methods or systems. The description of the foregoing embodiments is intended to be illustrative, and not to limit the scope of the claims. Many alternatives, modifications, and variations will be apparent to those skilled in the art.

1. A method for facilitating transfer of an available liquor license on a wide area network, the wide area network comprising, in operable communication, a buyer system, a seller system and a liquor license transfer system, the liquor license transfer system comprising a liquor license database, the method comprising:
a) the liquor license transfer system displaying on the buyer system a listing of the available liquor license and at least one comparable on a user interface generated by the liquor license transfer system, wherein the at least one comparable is a previously transferred liquor license record that is stored in the liquor license database;
b) the liquor license transfer system receiving an offer for the available liquor license from the buyer system and validating the offer;
c) upon the liquor license transfer system validating the offer, the liquor license transfer system generating and transmitting a notification of the offer to the seller system; and
d) upon the liquor license transfer system receiving an acceptance, the liquor license transfer system retrieving one or more electronic forms required to effectuate transfer of ownership of the available liquor license and auto-populating the forms with information relating to the buyer system and the seller system.

2. The method of claim 1 wherein the listing of the available liquor license comprises a liquor license number, a liquor license type and an address of the liquor license.

3. The method of claim 2 wherein the liquor license database comprises a plurality of the previously transferred liquor license records and wherein each previously transferred liquor license record comprises information relating to a transfer of a liquor license, the information comprising a date of previous transfer, a liquor license type, a transaction type, a county, a city and consideration paid for previous transfer of the liquor license.

4. The method of claim 3 wherein each of the previously transferred liquor license records are stored in the liquor license database only after approval by an administrator of the liquor license transfer system, the administrator only approving each of the previously transferred liquor license records when each of the previously transferred liquor license records present an accurate reflection of fair market value.

5. The method of claim 4 wherein the administrator uses objective and subjective criteria when approving each of the previously transferred liquor license records.

6. The method of claim 5 wherein the subjective criteria comprises influence that a relationship of the parties had on the transfer, if the transfer was between related parties; influence of the transaction type; whether the consideration reflects that property or good will was transferred contemporaneously with the liquor license; how close the consideration is to the median sales price in the same geographic area; market trend for the particular geographic area for that particular type of liquor license; and supply and demand of a particular geographic area for a specific liquor license type.

7. The method of claim 5 wherein the objective criteria comprises the date the previously transferred liquor license was transferred, the liquor license type of the previously transferred liquor license, the transfer type of the previously transferred liquor license, the address of the previously transferred liquor license prior to transfer, the consideration paid for the transfer of the previously transferred liquor license and whether the transfer of the previously transferred liquor license was between related parties.

8. (canceled)

9. The method of claim 3 wherein, prior to step a), the method further comprises:
the liquor license transfer system comparing the liquor license type and the city and/or county of the available liquor license with the liquor license type and the city and/or county of each of the plurality of previously transferred liquor license records,
upon the available liquor license and the at least one previously transferred liquor license record having the same liquor license type and the same city and/or county, the at least one previously transferred liquor license record becoming the at least one comparable and the liquor license transfer system associating the available liquor license listing with the at least one comparable.

10. The method of claim 1 wherein the available liquor license is a surrendered liquor license and wherein, prior to step a), the method further comprises:
the liquor license transfer system uploading information relating to the available liquor license from a local control board system using a data script, the local control board system part of the wide area network;
the liquor license transfer system creating the listing for the available liquor license and storing the listing in the liquor license database; and
the liquor license transfer system determining the at least one comparable for the available liquor license.

11. (canceled)

12. The method of claim 10 further comprising:
the liquor license transfer system further searching the local control board system on a periodic basis for a plurality of other surrendered liquor licenses using the data script, each of the other surrendered liquor licenses having a surrendered status;
the liquor license transfer system uploading information relating to the plurality of other surrendered liquor licenses using the data script; and
the liquor license transfer system creating a plurality of listings for the plurality of other surrendered liquor licenses and storing the plurality of listings in the liquor license database.

13. The method of claim 12 wherein the data script is further configured to search the local control board system on the periodic basis for all liquor licenses whose status has changed from surrendered and to remove all listings of liquor licenses with statuses changed from surrendered from the liquor license database.

14. (canceled)

15. The method of claim 1 wherein step b) comprises:
an administrator of the liquor license transfer system comparing the offer to the at least one comparable liquor license listing; and
the administrator validating the offer if the offer is within a predetermined threshold of consideration paid for the at least one comparable liquor license listing.

16. (canceled)

17. The method of claim 1 further comprising, after step d):
the liquor license transfer system delivering the auto-populated local control board forms to the seller system and the buyer system.

18. A method of displaying data for facilitating the transfer of surrendered liquor licenses on a wide area network, the wide area network comprising, in operable communication, a liquor license transfer system, a buyer system and a local control board system, the method comprising:
a) the liquor license transfer system searching the local control board system on a periodic basis for surrendered liquor licenses using a data script;
b) the liquor license transfer system uploading information relating to the surrendered liquor licenses identified in step a);
c) the liquor license transfer system creating an available liquor license listing for each surrendered liquor license and storing the available liquor license listings to a liquor license database residing on the liquor license transfer system, the liquor license database also storing previously transferred liquor license records;
d) for each available liquor license listing, the liquor license transfer system searching the previously transferred liquor license records and determining at least one comparable, wherein each comparable is a previously transferred liquor license record; and
e) upon a particular available liquor license listing meeting criteria established by the buyer system that is searching the liquor license database, displaying the particular available liquor license listing and the at least one comparable identified in step d) on the buyer system via a user interface generated by the liquor license transfer system.

19. The method of claim 18 wherein each of the available liquor license listings comprise a liquor license number, a liquor license type, a business name and a business address for each surrendered liquor license.

20. The method of claim 19 wherein each of the previously transferred liquor license records comprise information relating to a transfer of a liquor license, the information comprising a date the liquor license was transferred, a liquor license type, a transferor, a transferee, an address of the liquor license prior to transfer and consideration paid for the transfer.

21. The method of claim 20 wherein step d) comprises:
the liquor license transfer system comparing the liquor license type and the city and/or county of liquor license for each of the available liquor license listings with the liquor license type and the city and/or county of liquor license for each of the plurality of previously transferred liquor license records, and
upon one of the available liquor license listings and one of the at least one previously transferred liquor license records having the same liquor license type and the same city and/or county, the one of the at least one previously transferred liquor license records becoming the at least one comparable and the liquor license transfer system associating the one of the available liquor license listings with the at least one comparable in the liquor license database.

22. The method of claim 20 wherein the liquor license database stores each of the previously transferred liquor license records only after approval by an administrator of the liquor license transfer system, the administrator only approving each of the previously transferred liquor license records when each of the previously transferred liquor license records present an accurate reflection of fair market value.

23. The method of claim 22 wherein the administrator uses objective and subjective criteria when approving each of the previously transferred liquor license records, the subjective criteria comprising influence that a relationship of the parties had on the transfer, if the transfer was between related parties; influence of the transaction type; whether the consideration reflects that property or good will was transferred contemporaneously with the liquor license; how close the consideration is to the median sales price in the same geographic area; market trend for the particular geographic area for that particular type of liquor license; and supply and demand of a particular geographic area for a specific liquor license type.

24.-27. (canceled)

28. A method of determining comparable liquor licenses for a liquor license transfer system, the liquor license transfer system comprising a liquor license database and residing on a wide area network, the wide area network comprising, in operable communication, a buyer system and the liquor license transfer system, the method comprising:
a) an administrator of the liquor license transfer system reviewing information relating to a plurality of previously transferred liquor licenses, the information comprising a date the liquor license was transferred, a liquor license type, a transferor, a transferee, a transfer type, an address of the liquor license prior to transfer and consideration paid for the transfer;
b) upon the administrator approving a particular previously transferred liquor license, the liquor license transfer system storing the information relating to the particular previously transferred liquor license in the liquor license database as a previously transferred liquor license record;
wherein the administrator only approves the particular previously transferred liquor license when the information relating to the previously transferred liquor license represents an accurate reflection of fair market value;
c) the liquor license transfer system determining at least one comparable for an available liquor license listing, the particular previously transferred liquor license record being one of the at least one comparable for the available liquor license listing; and
d) upon receiving a request from the buyer system to display the available liquor license listing, the liquor license transfer system displaying the available liquor license listing and the at least one comparable on the buyer system via a user interface generated by the liquor license transfer system.

29.-69. (canceled)
